(19) United States
(12) Patent Application Publication
(10) Pub. No.: US 2024/0222612 A1
(43) Pub. Date: Jul. 4, 2024

(54) ANODE MATERIAL, METHOD FOR PREPARING THE SAME, AND SECONDARY BATTERY

(71) Applicants: BTR NEW MATERIAL GROUP CO., LTD., Shenzhen, Guangdong (CN); Dingyuan New Energy Technology Co., LTD., Huizhou City, Guangdong Province (CN)

(72) Inventors: Weili AN, Shenzhen, Guangdong (CN); Peng HE, Shenzhen, Guangdong (CN); Jianguo REN, Shenzhen, Guangdong (CN); Xueqin HE, Shenzhen, Guangdong (CN)

(21) Appl. No.: 18/558,525

(22) PCT Filed: Jun. 27, 2023
(86) PCT No.: PCT/CN2023/102585

§ 371 Date: Nov. 1, 2023

(30) Foreign Application Priority Data
Jun. 27, 2022 (CN) 202210745341.6

(51) Int. Cl. H01M 4/38; H01M 4/02; H01M 4/36; H01M 4/62

(52) U.S. Cl. CPC H01M 4/386; H01M 4/366; H01M 4/622; H01M 4/625; H01M 2004/021; H01M 2004/027

(57) ABSTRACT

The present disclosure relates to the field of anode materials, and provides an anode material, a method for preparing the anode material, and a secondary battery. The anode material has a core-shell structure. The core includes a silicon-based active material. The shell includes a connecting layer, a buffer layer and a protective layer. The connecting layer is coated on the surface of the silicon-based active material. The buffer layer is filled between the connecting layer and the protective layer. The connecting layer is connected to the buffer layer via a covalent bond. The anode material of the present disclosure has low cost and can be produced on a large scale, and the method for preparing the anode material can reduce the volumetric expansion of the anode material and improve the structural stability and cycle stability of the anode material.

The present disclosure claims the benefit of priority of Chinese patent application No. 2022107453416 filed with the China Patent Office on Jun. 27, 2022, entitled “COMPOSITE ANODE MATERIAL, METHOD FOR PREPARING THE SAME, AND LITHIUM BATTERY”, the content of which is hereby incorporated by reference in its entirety.

### TECHNICAL FIELD

The present disclosure relates to the technical field of anode materials, in particular to an anode material, method for preparing the anode material, and a secondary battery.

### BACKGROUND

Lithium-ion batteries have been widely used in electric vehicles and consumer electronics due to their advantages of high energy density, high output power, long cycle life and environmental friendliness. In order to improve battery energy density, the research and development of high-capacity anode materials are becoming more and more mature. However, large volumetric expansion may occur during a process of alloying these anode materials with lithium, and the anode materials will be pulverized to fall from the collector during a charge and discharge process, so that electrical touch between the anode materials and the collector is lost, resulting in worse electrochemical performance, capacity attenuation, declined cycle stability and difficult commercial application.

### SUMMARY

The present disclosure provides an anode material, a method for preparing the anode material, and a secondary battery. The anode material provided by the present disclosure has lowered volumetric expansion and improved cycle stability.

In a first aspect, the present disclosure provides an anode material, the anode material has a core-shell structure. A core includes a silicon-based active material. A shell includes a connecting layer, a buffer layer and a protective layer. The connecting layer is coated on the surface of the silicon-based active material. The buffer layer is filled between the connecting layer and the protective layer. The connecting layer is connected to the buffer layer via a covalent bond.

In the solution above, by constructing the connecting layer, the buffer layer and the protective layer on the surface of the silicon-based active material, and by using a synergistic effect thereof, the volumetric expansion of the silicon-based active material is effectively alleviated, the structure stability of the silicon-carbon anode material is enhanced, and cycle life of the anode material is improved. The connecting layer on the surface of the silicon-based active material can greatly improve the conductivity of the material, reduce the occurrence of side reactions, improve the lithium ion-electron transmission path, thereby improving the conductivity of the anode material and enhancing the rate performance of the anode material. The buffer layer filled between the connecting layer and the protective layer is connected to the connecting layer via a covalent bond, so that the falling off of the buffer layer caused by the volumetric expansion of the silicon-based active material during the charge and discharge is reduced, which in turn is beneficial to the anode material to maintain excellent mechanical properties, improve the structural stability of the anode material, and further improve the cycle stability of the anode material.

The present disclosure further provides an anode material, the anode material has a core-shell structure. A core includes a silicon-based active material. A shell includes a connecting layer, a buffer layer and a protective layer. The connecting layer is coated on the surface of the silicon-based active material, the buffer layer is filled between the connecting layer and the protective layer, and the average bonding force F between the connecting layer and the buffer layer is >8μ N.

In the solution above, by constructing the connecting layer, the buffer layer and the protective layer on the surface of the silicon-based active material and using the synergistic effect thereof, the volumetric expansion of the silicon-based active material is effectively alleviated, the structure stability of the silicon-carbon anode material is enhanced, and cycle life is improved. The connecting layer on the surface of the silicon-based active material can greatly improve the conductivity of the anode material, reduce the occurrence of side reactions, improve the lithium ion-electron transmission path, thereby improving the conductivity of the anode material and enhancing the rate performance of the anode material. The average bonding force between the buffer layer filled between the connecting layer and the protective layer, and the connecting layer is greater than 8 μN, so that it is not easy for the buffer layer to fall off from the connecting layer during the cycling process, which in turn is beneficial to the anode material to maintain excellent mechanical properties, improve the structural stability of the anode material, and further improve the cycle stability of the anode material.

The present disclosure further provides an anode material. The anode material has a core-shell structure. The core includes a silicon-based active material. The shell includes a connecting layer and a protective layer. The connecting layer is coated on the surface of the silicon-based active material. The protective layer includes a conductive substrate and a hollow carbon material dispersed in the conductive substrate. The average bonding force F between the connecting layer and the hollow carbon material is >8μ N.

In the solution above, by constructing the connecting layer and the protective layer on the surface of the silicon-based active material and using the synergistic effects thereof, the volumetric expansion of the silicon-based active material is effectively alleviated, the structure stability of the silicon carbon anode material is enhanced, and cycle life of the anode material is improved. The connecting layer on the surface of the silicon-based active material can greatly improve the conductivity of the anode material, reduce the occurrence of side reactions, improve the lithium ion-electron transmission path, thereby improving the conductivity of the anode material and enhancing the rate performance of the material. The conductive substrate in the protective layer can increase the conductivity of the anode material, and the hollow carbon material dispersed in the conductive substrate can buffer the volumetric expansion of the silicon-based active material. In addition, the average bonding force between the hollow carbon material and the connecting layer is greater than 8 μN, so that it is not easy for the hollow carbon material to fall off from the connecting layer during the cycling process, and thereby improving the connection stability between the protective layer and the connecting layer, which in turn is beneficial to the anode material to maintain excellent mechanical properties, improve the overall structural stability of the anode material, and further improve the cycle stability.

In a second aspect, the present disclosure provides a method for preparing an anode material. The method includes following steps:
forming a connecting layer on the surface of a silicon-based active material to obtain a first precursor, in which the connecting layer has a modified functional group;
polymerizing a mixed slurry containing the first precursor and a buffer layer material with surface functional groups, drying to obtain a second precursor; and
coating the second precursor to obtain the anode material.

In the solution above, by firstly forming a connecting layer with a modified functional group on the surface of a silicon-based active material to obtain a first precursor, and secondly conducting polymerization reaction between the buffer layer material and the first precursor, the connecting layer is covalently connected to the buffer layer, so that the bonding strength between the buffer layer and the connecting layer can be enhanced greatly to effectively and tightly connect the connecting layer and the buffer layer, and excellent electric contact can be ensured after volumetric expansion. Finally, a protective layer formed by coating the buffer layer can further improve the conductivity and structure integrity of the anode material, and effectively inhibit side reactions due to contact between the anode material and the electrolyte. Combining with synergistic effects of the connecting layer, the buffer layer and the protective layer on the silicon-based active material, and depending on the high strength and high toughness of the buffer layer, the anode material prepared by the method of the present disclosure can effectively relieve the volumetric expansion of silicon, improve the conductivity of the anode material, enhance the stability of the composite structure of the anode material, so as to improve cycle life and rate performance of the anode material.

In a third aspect, the present disclosure provides a secondary battery including the anode material as described in the first aspect or the anode material prepared by the method for preparing an anode material as described in the second aspect.

Compared with the prior art, beneficial effects of the present disclosure are as follows.

In the anode material provided by the present disclosure, by constructing the connecting layer, the buffer layer and the protective layer on the surface of the silicon-based active material and using the synergistic effect thereof, the volumetric expansion of the silicon-based active material is effectively alleviated, the structure stability of the silicon-carbon anode material is enhanced, and cycle life of the anode material is improved. The connecting layer on the surface of the silicon-based active material can greatly improve the conductivity of the material, reduce the occurrence of side reactions of materials, improve the lithium ion-electron transmission path, thereby improving the conductivity of the anode material and enhancing the rate performance of the anode material. The buffer layer filled between the connecting layer and the protective layer is connected to the connecting layer via a covalent bond, or the average bonding force between the buffer layer and the connecting layer is greater than 8 μN, so that it is beneficial to the anode material to maintain excellent mechanical properties, improve the structural stability of the anode material, and further improve the cycle stability of the anode material.

In the anode material provided by the present disclosure, by constructing the connecting layer and the protective layer on the surface of the silicon-based active material and using the synergistic effects thereof, the volumetric expansion of the silicon-based active material is effectively alleviated, the structure stability of the silicon-carbon anode material is enhanced, and cycle life is improved. The connecting layer on the surface of the silicon-based active material can greatly improve the conductivity of the material, reduce the occurrence of side reactions, improve the lithium ion-electron transmission path, thereby improving the conductivity of the anode material and enhancing the rate performance of the anode material. The conductive substrate in the protective layer can increase the conductivity of the anode material, and the hollow carbon material dispersed in the conductive substrate can buffer the volumetric expansion of the silicon-based active material. In addition, the average bonding force between the hollow carbon material and the connecting layer is greater than 8 μN, so that it is not easy for the hollow carbon material to fall off from the connecting layer during the cycling process, and thereby improving the connection stability between the protective layer and the connecting layer, so that it in turn can prevent the falling off of the buffer layer caused by the volumetric expansion of the silicon-based active material during the charge and discharge process, and it is beneficial to the anode material to maintain excellent mechanical properties, improve the overall structural stability of the anode material, and further improve the cycle stability of the anode material. In the method provided by the present disclosure, by firstly forming a connecting layer with a modified functional group on the surface of a silicon-based active material to obtain a first precursor, and secondly conducting polymerization reaction between the buffer layer material and the first precursor, the connecting layer is covalently connected to the buffer layer, so that the bonding strength between the buffer layer and the connecting layer can be enhanced greatly to effectively and tightly connect the connecting layer and the buffer layer, and excellent electric contact between the silicon-based active material and the buffer layer can be ensured after volumetric expansion of the silicon-based active material. Finally, a protective layer formed by coating the buffer layer can further improve the conductivity and structure integrity of the anode material, and effectively inhibit side reactions due to contact between the anode material and the electrolyte. Combining with synergistic effects of the connecting layer, the buffer layer and the protective layer on the silicon-based active material, and depending on the high strength and high toughness of the hollow carbon material of the buffer layer, the anode material prepared by the method of the present disclosure can effectively relieve the volumetric expansion of silicon, improve the conductivity of the silicon anode, enhance the stability of the silicon-carbon composite structure, so as to improve cycle life and rate performance of the silicon anode material.

### BRIEF DESCRIPTION OF DRAWINGS

FIG. 1 is a structural schematic diagram of an anode material provided by an example of the present disclosure;

FIG. 2 is another structural schematic diagram of an anode material provided by an example of the present disclosure;

FIG. 3 is a schematic flow chart of a method for preparing the anode material provided by an example of the present disclosure;

FIG. 4 is a scanning electron microscope image of the anode material provided by Example 1;

FIG. 5 is a Raman diagram of the anode material provided by Example 1; and

FIG. 6 is a curve graph of cyclic performance of the anode material provided by Example 1.

### DESCRIPTION OF EMBODIMENTS

The following descriptions are preferred embodiments of the present disclosure. It should be noted that a person skilled in the art can further make multiple improvements or modification without departing from the principle of the embodiments of the present disclosure, and these improvements or modification shall be considered as the scope of protection of the embodiments of the present disclosure.

At present, in lithium-ion batteries, the anode material is one of the key material that affect the charge and discharge performance of lithium-ion batteries. In order to improve the energy density of batteries, the research and development of high-capacity anode materials are becoming more and more mature. However, volumetric expansion is large during the alloying process of these anode materials with lithium, and the anode materials will be pulverized and fall off from the collector during the charge and discharge process, resulting in the loss of electrical touch between the anode materials and the collector, and eventually leading to worse electrochemical performance, capacity attenuation, decline in cycle stability of the anode material and accordingly making it difficult to realize commercial applications. For the purpose of improving the cycle stability of lithium-ion batteries, the embodiments of the present disclosure provides an anode material with low expansion and excellent stability.

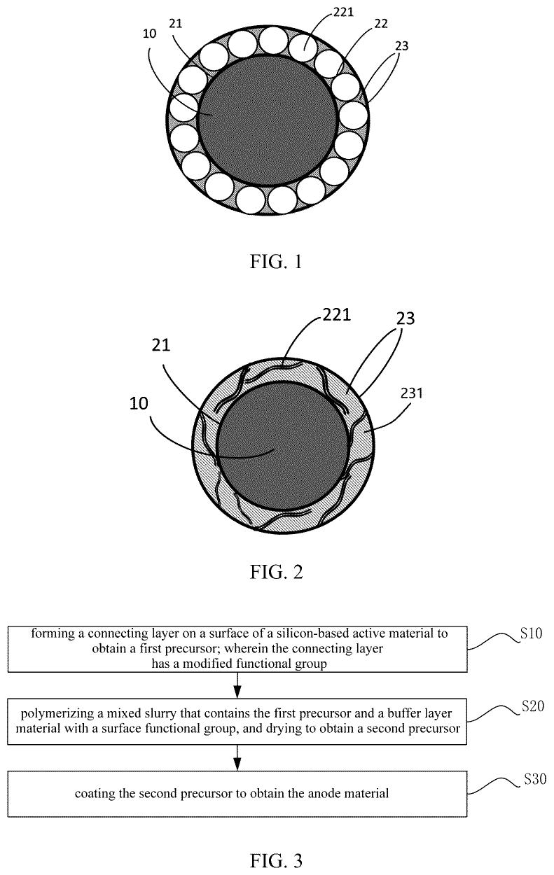

The present disclosure provides an anode material. As shown in FIG. 1, the anode material has a core-shell structure. The core includes a silicon-based active material 10. The shell includes a connecting layer 21, a buffer layer 22 and a protective layer 23. The connecting layer 21 is coated on the surface of the silicon-based active material 10, the buffer layer 22 is filled between the connecting layer 21 and the protective layer 23, and the connecting layer 21 is connected to the buffer layer 22 via a covalent bond.

In the solution above, by constructing the connecting layer, the buffer layer and the protective layer on the surface of the silicon-based active material, and by using a synergistic effect thereof, the volumetric expansion of the silicon-based active material is effectively alleviated, the structure stability of the anode material is enhanced, and cycle life of the anode material is improved. Specifically, the connecting layer on the surface of the silicon-based active material can greatly improve the conductivity of the material, reduce the occurrence of side reactions, improve the lithium ion-electron transmission path, thereby improving the conductivity of the anode material and enhancing the rate performance of the material. The buffer layer filled between the connecting layer and the protective layer is connected to the connecting layer via a covalent bond, so that it is beneficial to the anode material to maintain excellent mechanical properties and improve the structural stability of the anode material.

In some embodiments, the covalent bond includes at least one of a carbon-carbon bond (C—C, C═C), a carbon-oxygen bond (C—O, C═O), a carbon-nitrogen bond (C—N), a carbon-sulfur bond (C—S), a carbon-chlorine bond (C—Cl), a fluoro-carbon bond (C—F), a nitrogen-oxygen bond (O—N), an oxygen-sulfur bond (O—S), an oxygen-chlorine bond (O—Cl) and a nitrogen-sulfur bond (N—S).

In some embodiments, the core can be a silicon-based active material, and the silicon-based active material is primary particles.

In some embodiments, the silicon-based active material includes at least one of Si, SiOx and silicon alloy, in which 0<x<2. Specifically, SiOx can be but not limited to SiO_{0.1}, SiO_{0.2}, SiO_{0.3}, SiO_{0.4}, SiO_{0.6}, SiO_{0.8}, SiO, SiO_{1.2}, SiO_{1.5}, SiO_{1.8}, or SiO_{1.9}, etc. The silicon alloy can be silicon-iron alloy particles, silicon-cobalt alloy particles, silicon-nickel alloy particles, silicon-copper alloy particles, silicon-platinum alloy particles or silicon-gold alloy particles.

In some embodiments, the median particle diameter of the silicon-based active material is 0.2 μm to 20 μm, specifically, it can be, but not limited to 0.2 μm, 0.5 μm, 1 μm, 2 μm, 5 μm, 10 μm, 15 μm or 20 μm.

In some embodiments, the connecting layer includes at least one of a polymer, an amorphous carbon material and a graphitized carbon material.

In some embodiments, as shown in FIG. 1, the buffer layer includes a hollow carbon material 221.

In some embodiments, as detected by focused ion beam scanning electron microscope (FIB-SEM), X-ray photoelectron spectroscopy, electron energy loss spectroscopy or infrared absorption spectrometer, there are multiple covalent bonds at the connection position between the connecting layer and the hollow carbon material of the buffer layer, the covalent bonds includes at least one of a carbon-carbon bond (C—C, C═C), a carbon-oxygen bond (C—O, C═O), a carbon-nitrogen bond (C—N), a carbon-sulfur bond (C—S), a carbon-chlorine bond (C—Cl), a fluoro-carbon bond (C—F), a nitrogen-oxygen bond (O—N), an oxygen-sulfur bond (O—S), an oxygen-chlorine bond (O—Cl) and a nitrogen-sulfur bond (N—S).

In a second aspect, the present disclosure provides an anode material. The anode material has a core-shell structure. The core includes a silicon-based active material. The shell includes a connecting layer, a buffer layer and a protective layer. The connecting layer is coated on the surface of the silicon-based active material. The buffer layer is filled between the connecting layer and the protective layer, and the average bonding force F between the connecting layer and the buffer layer is >8μ N.

A method for testing an average bonding force F between the connecting layer and the buffer layer is as follows: five minimum pulling forces required for detaching the hollow carbon material from the connecting layer are measured by a nano mechanical test system and a probe test system, and are averaged to obtain the average bonding force.

It can be understood that larger the average bonding force is, firmly contact between the buffer layer and the connecting layer can be ensured, the separation between the buffer layer and the connecting layer due to the large stress generated after the silicon based active material is embedded with lithium is reduced, so that electron conduction of the anode material is enhanced. The hollow carbon material in the buffer layer can effectively relieve the volumetric expansion of the silicon. Further, the tight binding between the hollow carbon material and the connecting layer can reduce material polarization, decrease the contact resistance of the anode material, accelerate lithium-ion transmission, and bring high capacity and high rate performance.

In some embodiments, the buffer layer includes at least one of hollow carbon sphere, hollow carbon rod and hollow carbon tube.

In some embodiments, the hollow carbon material includes a hollow carbon sphere, and the diameter of the hollow carbon sphere is 20 nm to 2000 nm, the wall thickness of the hollow carbon sphere is 5 nm to 500 nm. Specifically, the diameter can be, but not limited to 20 nm, 50 nm, 80 nm, 100 nm, 200 nm, 500 nm, 800 nm, 1000 nm, 1500 nm or 2000 nm, etc., specifically it can be, but not limited to 5 nm, 50 nm, 80 nm, 100 nm. 150 nm, 200 nm, 250 nm, 300 nm, 450 nm, or 500 nm etc.

In some embodiments, the hollow carbon material includes a hollow carbon rod, a diameter of the hollow carbon rod is 10 nm to 1000 nm, a length of the hollow carbon rod is 100 nm to 3000 nm, and a wall thickness of the hollow carbon rod is 5 nm to 500 nm. Specifically, the diameter can be, but not limited to 10 nm, 50 nm, 80 nm, 100 nm, 200 nm, 500 nm, 600 nm, 700 nm, 850 nm or 1000 nm etc., the length can be, but not limited to 100 nm, 200 nm, 400 nm, 500 nm, 800 nm, 1000 nm, 2000 nm, 2500 nm or 3000 nm etc., the wall thickness can be, but not limited to 5 nm, 50 nm, 80 nm, 100 nm, 150 nm, 200 nm, 250 nm, 300 nm, 450 nm or 500 nm etc.

In some embodiments, the hollow carbon material includes a hollow carbon tube, a diameter of the hollow carbon tube is 20 nm to 400 nm, a length of the hollow carbon tube is 30 nm to 20 μm, and a wall thickness of the hollow carbon tube is 5 nm to 100 nm. Specifically, the diameter can be, but not limited to 20 nm, 50 nm, 80 nm, 100 nm, 200 nm, 250 nm, 300 nm, 350 nm, 380 nm or 400 nm etc., the length can be, but not limited to 30 nm, 50 nm, 100 nm, 200 nm, 400 nm, 500 nm, 800 nm, 1 μm, 8 μm, 10 μm, 15 μm or 20 μm etc., and the wall thickness can be, but not limited to 5 nm, 10 nm, 25 nm, 30 nm, 35 nm, 40 nm, 45 nm or 50 nm etc.

In some embodiments, a ratio of the thickness of the buffer layer to the median particle diameter D₅₀ of the silica-based active material is 1:(0.5 to 10). Specifically, the ratio can be, but not limited to 1:0.5, 1:0.7, 1:0.8, 1:0.9, 1:1.0, 1:1.5, 1:2.0, 1:3, 1:5, 1:6, 1:8 or 1:10 and so on. Preferably, the ratio of the thickness of the buffer layer and the median particle diameter D₅₀ of the silica-based active material is 1:(1 to 8).

In some embodiments, the protective layer is coated on the surface of the buffer layer.

In some embodiments, the protective layer is coated on the surface of the buffer layer, and at least part of the protective layer is filled in a gap of the hollow carbon material.

In some embodiments, the protective layer includes at least one of a polymer, an amorphous carbon material and a graphitized carbon material.

In some embodiments, the thickness of the connecting layer is 5 nm to 200 nm, specifically the thickness can be, but not limited to 5 nm, 10 nm, 30 nm, 50 nm, 80 nm, 100 nm, 150 nm, 180 nm or 200 nm etc.

In some embodiments, the thickness of the protective layer is 5 nm to 500 nm, specifically the thickness can be, but not limited to 5 nm, 50 nm, 80 nm, 100 nm, 150 nm, 200 nm, 250 nm, 300 nm, 450 nm or 500 nm etc.

In some embodiments, the protective layer includes at least one of amorphous carbon materials and a graphitized carbon material, in which the mass content of carbon element of the protective layer in the anode material is 1% to 50%, preferably 5% to 25%.

In some embodiments, the protective layer is a carbon layer composed of the amorphous carbon materials, the mass content of carbon layer in the anode material is 2% to 25%, the mass content of oxygen element in the carbon layer is <5%.

In some embodiments, the protective layer is a carbon layer composed of the graphitized carbon material, the mass content of carbon layer in the anode material is 2% to 15%, the mass content of oxygen element in the carbon layer is <3%.

In some embodiments, the graphitized carbon material is a modified graphene with doping element. The doping element includes at least one of oxygen, nitrogen and sulphur.

In some embodiments, the graphitized carbon material is a modified graphene with doping element, the number of layers of the modified graphene is <10. Too many layers of the modified graphene may lead to too great thickness of the protective layer and then too high content of carbon, which is disadvantageous to improve the rate performance of the material.

In some embodiments, the mass content of the doping element in the graphitized carbon material is 1% to 20%. Specifically, it can be, but not limited to 1%, 3%, 4%, 5%, 6%, 7%, 10%, 12%, 15%, 18% or 20% etc. The conductivity of the graphitized carbon material with doping element can be enhanced significantly.

In some embodiments, the protective layer includes a polymer, the polymer includes at least one of a double-block copolymer, a tri-block copolymer and a multi-block copolymer.

In some embodiments, the mass content of the polymer in the anode material is 1% to 20%, specifically, the mass content can be, but not limited to 1%, 3%, 5%, 8%, 10%, 12%, 15% or 20% etc.

In some embodiments, the polymer includes at least one of polyacrylic acid, polyacrylonitrile, polyimide, polyurethane, polydopamine, xanthan gum, polypyrrole, polythiophene, polyphenylacetylene, polyaniline, polyacetylene and tannic acid. Preferably, the polymer is at least one of polypyrrole, polythiophene, polyaniline, polyaniline and polyacetylene.

In a third aspect, the present disclosure provides an anode material. As shown in FIG. 2, the anode material has a core-shell structure. The core includes a silicon-based active material 10. The shell includes a connecting layer 21 and a protective layer 23. The connecting layer 21 is coated on the surface of the silicon-based active material 10. The protective layer 23 includes a conductive substrate 231 and a hollow carbon material 221 dispersed in the conductive substrate 231. The average bonding force F between the connecting layer 21 and the hollow carbon material 221 is >8 μN.

In the solution above, by constructing the connecting layer and the protective layer on the surface of the silicon-based active material and using the synergistic effects thereof, the volumetric expansion of the silicon-based active material is effectively alleviated, the structure stability of the silicon-carbon anode material is enhanced, and cycle life is improved. The connecting layer on the surface of the silicon-based active material can greatly improve the conductivity of the anode material, reduce the occurrence of side reactions, improve the lithium ion-electron transmission path, thereby improving the conductivity of the anode material and enhancing the rate performance of the anode material. The conductive substrate in the protective layer can increase the conductivity of the material, and the hollow carbon material dispersed in the conductive substrate can buffer the volumetric expansion of the silicon-based active material. In addition, the average bonding force between the hollow carbon material and the connecting layer is greater than 8 μN, so that it is not easy for the hollow carbon material to fall off from the connecting layer during the cycling process, and thereby improving the connection stability between the protective layer and the connecting layer, which in turn is beneficial to the anode material to maintain excellent mechanical properties, improve the overall structural stability of the anode material, and further improve the cycle stability.

In some embodiments, the conductive substrate includes at least one of a polymer, an amorphous carbon material and a graphitized carbon material. The selection for the polymer, the amorphous carbon material and the graphitized carbon material are the same as that described in the anode material of the first aspect, which won't be reiterated here.

In some embodiments, the protective layer is coated on the surface of the connecting layer.

In some embodiments, both the connecting layer and the protective layer include a polymer.

In some embodiments, both the connecting layer and the protective layer include an amorphous carbon material.

In some embodiments, both the connecting layer and the protective layer include a graphitized carbon material.

It can be understood that when the materials of the connecting layer and the protective layer are the same, the bonding force between the connecting layer and the protective layer is stronger, so that it is more beneficial to fixing the hollow carbon material between the connecting layer and the protective layer, preventing the hollow carbon material from falling off from the connecting layer during the charging and discharging process.

In some embodiments, the mass content of carbon element in the anode material is 5% to 80%. Specifically, it can be, but not limited to 5%, 8%, 10%, 15%, 18%, 20%, 30%, 35%, 40%, 45%, 50% or 80% etc. It should be noted that the carbon in the anode material originates from the carbon of the connecting layer, the buffer layer and the protective layer.

In some embodiments, the mass content of oxygen element in the anode material is smaller than 20%. Specifically, it can be, but not limited to 5%, 6%, 8%, 10%, 12%, 15%, 18%, 19% etc.

In some embodiments, the powder tap density of the anode material is 0.2 g/cm³ to 1.2 g/cm³, for example 0.2 g/cm³, 0.3 g/cm³, 0.5 g/cm³, 0.6 g/cm³, 0.7 g/cm³, 0.8 g/cm³. 1.0 g/cm³, 1.2 g/cm³ and so on. Preferably the powder tap density is 0.5 g/cm³ to 0.8 g/cm³.

In some embodiments, the powder compaction density of the anode material is 1.2 g/cm³ to 1.8 g/cm³, for example 1.2 g/cm³, 1.3 g/cm³, 1.4 g/cm³, 1.5 g/cm³, 1.6 g/cm³ or 1.8 g/cm³ etc., preferably the powder compaction density is 1.45 g/cm³ to 1.75 g/cm³.

In some embodiments, the median particle diameter of the anode material is 0.2 μm to 20 μm, optionally, the median particle diameter of the anode material can specifically be, but not limited to 0.2 μm, 0.5 μm, 1 μm, 3 μm, 4 μm, 5 μm, 7 μm, 10 μm, 13 μm, 15 μm or 20 μm etc. Preferably, the median particle diameter of the anode material is 0.5 μm to 10 μm, more preferably 1 μm to 5 μm.

The specific surface area of the anode material is 1 m²/g to 50 m²/g. Alternatively, it can be, but not limited to 1 m²/g, 5 m²/g, 8 m²/g, 10 m²/g, 15 m²/g, 20 m²/g, 25 m²/g, 30 m²/g, 35 m²/g, 40 m²/g, 45 m²/g or 50 m²/g and so on. It can be understood that the smaller the specific surface area is, the better will be. A SEI film may be formed easily when the specific surface area is too large, which will lead to excessive consumption of irreversible lithium salt, and further lead to low primary efficiency of batteries. Considering the cost of the preparation process, the specific surface area is controlled between 2 m²/g and 15 m²/g.

The present disclosure further provides a method for preparing an anode material, as shown in FIG. 3, the method including following steps.

S10, a connecting layer is formed on the surface of a silicon-based active material to obtain a first precursor; in which the connecting layer has a modified functional group.

S20, a mixed slurry containing the first precursor and a buffer layer material with surface functional groups is polymerized, and dried to obtain a second precursor.

S30, the second precursor is coated to obtain the anode material.

The anode material prepared through the above method has a core-shell structure, in which the core includes a silicon-based active material, the shell includes a connecting layer, a buffer layer and a protective layer, the connecting layer is coated on the surface of the silicon-based active material, the buffer layer is filled between the connecting layer and the protective layer.

In the solution, by firstly forming a connecting layer with a modified functional group on the surface of a silicon-based active material to obtain a first precursor, and secondly conducting polymerization reaction between the buffer layer material and the first precursor to covalently connect the connecting layer and the buffer layer, the connecting layer is covalently connected to the buffer layer, so that the bonding strength between the buffer layer and the connecting layer can be enhanced greatly to effectively and tightly connect the connecting layer and the buffer layer, and excellent electric contact between the connecting layer and the buffer layer can be ensured after volumetric expansion of the silicon-based active material. Finally, a protective layer formed by coating the buffer layer can further improve the conductivity and structure integrity of the anode material, and effectively inhibit side reactions due to contact between the anode material and the electrolyte. Combining with synergistic effects of the connecting layer and the protective layer on the silicon-based active material, and depending on the high strength and high toughness of the buffer layer, the anode material prepared by the method of the present disclosure can effectively relieve the volumetric expansion of the silicon-based active material, improve the conductivity of the anode material, enhance the stability of the composite structure of the anode material, so as to improve cycle life and rate performance of the anode material.

Preparation methods of the present disclosure will be described in detail with reference to the following embodiments.

Step S10, a connecting layer is formed on the surface of a silicon-based active material to obtain a first precursor; in which the connecting layer has a modified functional group.

In some embodiments, the silicon-based active material is primary particles.

In some embodiments, the silicon-based active material includes at least one of Si, SiOx and silicon alloy, in which 0<x<2. Specifically, SiOx can be but not limited to SiO_{0.1}, SiO_{0.2}, SiO_{0.3}, SiO_{0.4}, SiO_{0.6}, SiO_{0.8}, SiO, SiO_{1.2}, SiO_{1.5}, SiO_{1.8}, or SiO_{1.9}, etc. The silicon alloy can be silicon-iron alloy particles, silicon-cobalt alloy particles, silicon-nickel alloy particles, silicon-copper alloy particles, silicon-platinum alloy particles or silicon-gold alloy particles.

In some embodiments, the median particle diameter D₅₀ of the silicon-based active material is 0.2 μm to 20 μm, specifically, it can be, but not limited to 0.2 μm, 0.5 μm, 1 μm, 2 μm, 5 μm, 10 μm, 15 μm or 20 μm.

In some embodiments, manners of the modifying treatment of the connecting layer can be gas modification and/or liquid phase modification.

In some embodiments, Step S10 includes: a gaseous carbon source is deposited on the surface of the silicon-based active material by vapour deposition under a protective atmosphere to obtain a composite, and then the connecting layer on the surface of the composite has a modified functional group by using a modifying gas.

In some embodiments, the heating rate of the vapour deposition is 1° C./min to 20° C./min, for example, the heating rate can be, but not limited to 1° C./min, 3° C./min, 5° C./min, 8° C./min, 10° C./min, 15° C./min or 20° C./min.

In some embodiments, the temperature of the vapor deposition is 600° C. to 1000° C., specifically, it can be, but not limited to 400° C., 500° C., 600° C., 700° C., 800° C., or 1000° C.

In some embodiments, the gaseous carbon source includes at least one of acetylene, methane, toluene, cyclohexane, ethanol, ethylene and propylene.

In some embodiments, the concentration of the gaseous carbon source is 0.1 L/min to 10 L/min, specifically it can be, but not limited to 0.1 L/min, 1 L/min, 3 L/min, 5 L/min, 8 L/min or 10 L/min.

In some embodiments, the heat-preserved time of the vapor deposition is 1 h to 48 h, specifically it can be, but not limited to 1 h, 2 h, 4 h, 6 h, 8 h, 12 h, 18 h, 24 h or 48 h.

In some embodiments, the modifying gas includes at least one of oxygen, water steam, ammonia, hydrogen sulfide, phosphine, hydrogen chloride, hydrogen fluoride, hydrogen bromide, nitric oxide, sulfur dioxide and chlorine.

In some embodiments, the flow rate of the modifying gas is 0.5 L/min to 5 L/min, specifically it can be, but not limited to 0.5 L/min, 1 L/min, 2 L/min, 3 L/min, 4 L/min or 5 L/min.

In some embodiments, the feeding time of the modifying gas is 0.5 h to 10 h, specifically, it can be, but not limited to 0.5 h, 2 h, 4 h, 6 h, 8 h or 10 h.

In some embodiments, a modified functional group is selected from at least one of carboxyl, carbonyl, hydroxyl, epoxy group, nitrogen-containing functional group, sulfur-containing functional group, halogen-containing functional group and derived functional group thereof.

In some embodiments, the protective atmosphere includes at least one of helium, neon, argon, krypton and xenon.

In some embodiments, a volume ratio of the protective atmosphere to the gaseous carbon source is 10:(0.5 to 10), specifically, it can be, but not limited to 10:0.5, 10:1, 10:2, 10:3, 10:4, 10:5, 10:7, 10:8, 10:9 or 10:10.

In some embodiments, a volume ratio of the protective atmosphere to the modifying gas is 10:(0.1 to 10), specifically, it can be, but not limited to 10:0.1, 10:1, 10:2, 10:3, 10:4, 10:5, 10:7, 10:8, 10:9 or 10:10.

In some embodiments, Step S10 includes: a gaseous carbon source is deposited on the surface of the silicon-based active material by vapour deposition under a protective atmosphere to obtain a composite, and then the composite is dispersed in a first modified solution containing a first modifying agent, solid-liquid separated, dried and heat treated to obtain a first precursor.

The methods of preparing the composite are described as above, which won't be reiterated here.

In some embodiments, the first modifying agent includes an anionic surfactant.

In some embodiments, the first modifying agent includes at least one of cetyl trimethyl ammonium bromide, cetyl sodium sulfate, polyvinylpyrrolidone and sodium polystyrene sulfonate.

In some embodiments, the mass ratio of the composite and the first modifying agent in the first modified solution is 1:(0.05 to 1), specifically, it can be, but not limited to 1:0.05, 1:0.1, 1:0.2, 1:0.4, 1:0.5, 1:0.7, 1:0.8, 1:0.9 or 1:1.

In some embodiments, the first modified solution includes a polar solvent.

In some embodiments, the polar solvent includes at least one of water, anhydrous ethanol, methanol and isopropyl alcohol.

In some embodiments, manners for dispersing include at least one of mechanical stirring and ultrasonic dispersion.

In some embodiments, the solid-liquid separation includes at least one of centrifugation, atmospheric pressure filtration and negative pressure filtration.

In some embodiments, the temperature for drying is 60° C. to 200° C., specifically, the temperature for drying can be, but not limited to 60° C., 80° C., 100° C., 120° C., 150° C., 180° C. or 200° C.

In some embodiments, forming a connecting layer with a modified functional group by using the first modifying agent further includes heat treating the dried product, and the temperature for the heat treating is 600° C. to 900° C., the time for the heat treating is 1 h to 6 h.

In some embodiments, the temperature for the heat treating can specifically be, but not limited to 600° C., 650° C., 700° C., 720° C., 750° C., 800° C., 850° C. or 900° C., the time for the heat treating can specifically be, but not limited to 1 h, 2 h, 3 h, 4 h, 5 h or 6 h. In some embodiments, Step S10 includes: the mixed coating liquid containing the silicon-based active substance and the polymer is spray dried, so that a connecting layer including the polymer is formed on the surface of the silicon-based active material.

In some embodiments, the solid content of the silicon-based active material in the mixed coating liquid is 5% to 50%.

In some embodiments, the mixed coating liquid includes a polar solvent.

In some embodiments, the polar solvent includes at least one of water, anhydrous ethanol, methanol and isopropyl alcohol.

In some embodiments, the mass ratio of the silicon-based active material and the polymer is 10:(0.1 to 5), specifically, it can be, but not limited to 10:0.1, 10:1, 10:2, 10:3, 10:4 or 10:5.

In some embodiments, the temperature for drying is 60° C. to 200° C., specifically, the temperature for drying can be, but not limited to 60° C., 80° C., 100° C., 120° C., 150° C., 180° C. or 200° C.

In some embodiments, the polymer includes at least one of a double-block copolymer, a tri-block copolymer and a multi-block copolymer.

In some embodiments, the polymer includes at least one of polyacrylic acid, polyacrylonitrile, polyimide, polyurethane, polydopamine, xanthan gum, polypyrrole, polythiophene, polyphenylacetylene, polyaniline, polyacetylene and tannic acid.

In some embodiments, the polymer has a modified functional group, and the modified functional group are selected from at least one of carboxyl, carbonyl, hydroxyl, epoxy group, nitrogen-containing functional group, sulfur-containing functional group, halogen-containing functional group and derived functional group thereof.

In some embodiments, before step S20, the method further includes: the buffer layer material is dispersed in a second modified solution containing a second modifying agent to perform a modifying treatment, and then solid-liquid separated, dried to obtain the buffer layer material with surface functional group.

In some embodiments, the second modifying agent includes a cationic surfactant.

In some embodiments, the second modifying agent includes at least one of polydiallyl dimethylammonium chloride, aminopropyl triethoxysilane and a silane coupling agent.

In some embodiments, the mass ratio of the buffer layer material to the second modifying agent in the second modified solution is 1:(0.5 to 10), specifically, the mass ratio can be 1:0.5, 1:1, 1:2, 1:3, 1:4, 1:5, 1:6, 1:8 or 1:10 and the like.

In some embodiments, the second modified solution includes a polar solvent.

In some embodiments, the polar solvent includes at least one of water, anhydrous ethanol, methanol and isopropyl alcohol.

In some embodiments, the solid-liquid separation includes at least one of centrifugation, atmospheric pressure filtration and negative pressure filtration.

In some embodiments, the temperature for drying is 60° C. to 200° C., specifically, the temperature for drying can be, but not limited to 60° C., 80° C., 100° C., 120° C., 150° C., 180° C. or 200° C.

In some embodiments, manners for dispersing includes at least one of mechanical stirring and ultrasonic dispersion.

S20, the mixed slurry containing the first precursor and a buffer layer material with surface functional groups is polymerized, so that the surface functional groups of the buffer layer material is connected covalently to the modified functional group of the connecting layer, and drying is performed to obtain a second precursor.

It should be noted that the buffer layer material can be connected to the connecting layer on the surface of the silicon-based active material by self-assembly, electrostatic adsorption or spray granulation coating, and so on.

In some embodiments, in the mixed slurry, the mass ratio of the first precursor and the buffer layer material with surface functional group is 1:(0.01 to 2), specifically the mass ratio can be 1:0.01, 1:0.02, 1:0.05, 1:0.08, 1:0.1, 1:0.2, 1:0.5, 1:0.8, 1:1, 1:1.5 or 1:2 and so on. Preferably, the mass ratio of the first precursor and the buffer layer material with surface functional group is 1:(0.01 to 1).

In some embodiments, the solid content of the first precursor in the mixed slurry is 2% to 50%. Specifically, it can be, but not limited to 2%, 5%, 8%, 10%, 15%, 20%, 30%, 40% or 50% and so on.

In some embodiments, the solid content of the buffer layer material with surface functional group in the mixed slurry is 0.5% to 25%. Specifically, it can be, but not limited to 0.5%, 2%, 5%, 8%, 10%, 15%, 18%, 20% or 25% and so on.

In some embodiments, the buffer layer material includes a hollow carbon material, the hollow carbon material includes at least one of hollow carbon sphere, hollow carbon rod and hollow carbon tube.

In some embodiments, the solid content in the mixed slurry is 5% to 60%, specifically it can be, but not limited to 5%, 6%, 10%, 20%, 30%, 40%, 50% or 60% and so on.

In some embodiments, the mass ratio of the first precursor to an active agent in the mixed slurry is 1:(0.1 to 0.5). Specifically, it can be, but not limited to 1:0.1, 1:0.2, 1:0.3, 1:0.4 or 1:0.5 and so on.

In some embodiments, the mixed slurry is further dispersed and centrifuged, manners for dispersing include at least one of mechanical stirring and ultrasonic dispersion.

In some embodiments, the mixed slurry further includes an active agent, and the active agent is selected from at least one of polydiallyl dimethylammonium chloride, aminopropyl triethoxysilane, silane coupling agent, cetyl trimethyl ammonium bromide, cetyl sodium sulfate, polyvinylpyrrolidone and sodium polystyrene sulfonate.

In some embodiments, the mixed slurry further includes a solvent, and the solvent is selected from at least one of water, anhydrous ethanol, methanol and isopropyl alcohol.

In some embodiments, a drying manner is spray drying. The temperature for the spray drying is 100° C. to 200° C. Specifically, the temperature can be, but not limited to 100° C., 110° C., 120° C., 150° C., 170° C., 180° C. or 200° C.

In some embodiments, the feeding speed of the spray drying is 100 mL/min to 1000 mL/min, specifically it can be, but not limited to 100 mL/min, 200 mL/min, 300 mL/min, 400 mL/min, 600 mL/min, 800 mL/min or 1000 mL/min and so on.

S30, the second precursor is coated to obtain the anode material.

In some embodiments, the coating treatment includes carbon coating treatment and/or polymer coating treatment.

In some embodiments, the coating treatment can be conducted through vapour deposition, liquid phase coating, and organics cracking.

In some embodiments, the step for carbon coating the second precursor includes: a gaseous carbon source is introduced into the second precursor, and is heated until the gaseous carbon source starts a thermal cracking reaction, so that the surface of the second precursor is deposited to form a protective layer. The protective layer includes at least one of an amorphous carbon material and a graphitized carbon material.

In some embodiments, the gaseous carbon source includes at least one of acetylene, methane, toluene, cyclohexane, ethanol, ethylene and propylene.

In some embodiments, the heating rate is 1° C./min to 20° C./min, specifically it can be 1° C./min, 2° C./min, 3° C./min, 4° C./min, 5° C./min, 8° C./min, 10° C./min, 12° C./min, 15° C./min, 18° C./min, 20° C./min. Preferably, the heating rate is 3° C./min to 5° C./min. The applicant found through many experiments that when the heating rate is controlled at 3° C./minto 5° C./min, the carbonization reaction can be effectively guaranteed, and the time for heating to the preset temperature range can be shortened.

In some embodiments, the temperature of the thermal cracking reaction is 600° C. to 1000° C. Specifically, the temperature of the thermal cracking reaction can be 600° C., 650° C., 700° C., 750° C., 800° C., 890° C., 900° C., 960° C., or 1000° C. The applicant found through many experiments that the reaction efficiency can be improved by controlling the temperature of the thermal cracking reaction within 600° C. to1000° C., so that a uniform carbon layer can be formed on the surface of the second precursor, in which the carbon layer can be amorphous carbon. Preferably, the temperature of the thermal cracking reaction is 700° C. to 900° C.

In some embodiments, the heat-preserved time of the thermal cracking reaction is 1 h to 48 h. Specifically, it can be, but not limited to 1 h, 4 h, 8 h, 12 h, 16 h, 24 h, 28 h, 32 h, 38 h or 48 h.

In some embodiments, the concentration of the gaseous carbon source is 0.1 L/min to 10 L/min, specifically it can be, but not limited to 0.1 L/min, 0.4 L/min, 0.6 L/min, 0.8 L/min, 1.0 L/min, 2 L/min, 5 L/min, 6 L/min, 8 L/min, 9 L/min or 10 L/min.

In some embodiments, the thermal cracking reaction is conducted under a protective atmosphere.

In some embodiments, the protective atmosphere includes at least one of helium, neon, argon, krypton and xenon.

In some embodiments, a volume ratio of the protective atmosphere to the gaseous carbon source is 10:(0.5 to 10), specifically, it can be, but not limited to 10:0.5, 10:1, 10:2, 10:3, 10:5, 10:6.5, 10:7.5, 10:8.5, 10:9 or 10:10.

In some embodiments, the step of coating polymer to the second precursor includes: a mixed coating liquid containing the second precursor and the polymer is spray dried, so that a protective layer is formed on the surface of the second precursor. The protective layer includes the polymer.

In some embodiments, the solid content of the second precursor in the mixed coating liquid is 5% to 50%, specifically it can be, but not limited to 5%, 10%, 15%, 20%, 25%, 30%, 35%, 40%, 45% or 50%, etc.

In some embodiments, the mixed coating liquid includes a polar solvent.

In some embodiments, the polar solvent includes at least one of water, anhydrous ethanol, methanol and isopropyl alcohol.

In some embodiments, the mass ratio of the second precursor to the polymer is 10:(0.1 to 5), specifically it can be, but not limited to 10:0.1, 10:1, 10:2, 10:3, 10:4 or 10:5.

In some embodiments, the temperature for spray drying is 60° C. to 200° C., specifically, the temperature for spray drying can be 60° C., 80° C., 100° C., 120° C., 150° C., 180° C. or 200° C.

In some embodiments, the polymer includes at least one of a double-block copolymer, a tri-block copolymer and a multi-block copolymer.

In some embodiments, the polymer includes at least one of polyacrylic acid, polyacrylonitrile, polyimide, polyurethane, polydopamine, xanthan gum, polypyrrole, polythiophene, polyphenylacetylene, polyaniline, polyacetylene and tannic acid.

Embodiments of the present disclosure further provides a secondary battery in which the anode material provided by the above embodiments of the present disclosure or the anode material prepared by the method for preparing an anode material provided by the above embodiments of the present disclosure are used. The secondary battery can be a lithium-ion battery, a sodium-ion battery and the like. The lithium-ion battery provided by the embodiments of the present disclosure has high capacity, high first effect, long cycle life, excellent rate performance and low expansion.

The embodiments of the present disclosure will be further described with multiple Examples. The embodiments of the present disclosure are not limited to following Examples. Within the scope of the unchanging main rights, changes can be appropriately made.

### Example 1

A method for preparing an anode material includes following steps.
(1) Silicon with a median particle diameter of 2 μm was added into a rotation atmosphere furnace, and heated under the protection of argon atmosphere to 900° C. at a heating rate of 3° C./min, and then acetylene was introduced in 0.5 L/min until the volume ratio of the argon to the acetylene in the rotation atmosphere furnace was 9:1, heat-preserved for 3 h before turn off the acetylene. Ammonia was then introduced in 0.5 L/min until the volume ratio of the argon to the ammonia in the rotation atmosphere furnace was 10:1, and then heat-preserved for 3 h before turn off the ammonia, cooled down to obtain a composite. 10 g of the composite and cetyl trimethyl ammonium bromide in a mass ratio of 10:2 were dispersed in 200 ml deionized water, stirred for 30 minutes and sonicated for 10 minutes, centrifuged and dried to obtain a first precursor.
(2) 1 g hollow carbon sphere with a diameter of 100 nm and 1 g polydiallyl dimethylammonium chloride were dissolved in 100 ml deionized water, stirred for 30 minutes and sonicated for 20 minutes, and centrifuged and dried to obtain a hollow carbon sphere material with a hydroxylated surface. 10 g of the first precursor was dissolved in 100 ml deionized water, stirred for 10 minutes to obtain a solution E and 1 g modified hollow carbon sphere was dispersed in 100 ml deionized water, stirred for 10 minutes to obtain a solution F. The solution E was dropped into the solution F slowly, stirred for 40 minutes continuously and quickly, centrifuged and dried to obtain a second precursor.
(3) 10 g of the second precursor was taken and dissolved in 100 g anhydrous ethanol, 1 g polyacrylic acid was added and then stirred mechanically for 30 minutes, spray dried by controlling the drying temperature at 100° C., finally the anode material was obtained.

The anode material prepared by this example has a core-shell structure, in which the core includes silicon, the shell includes a connecting layer, a buffer layer and a protective layer, the connecting layer is an amorphous carbon material layer, and the amorphous carbon material layer is coated on the surface of the silicon particular, the buffer layer includes the hollow carbon sphere, the protective layer is a polymer (polyacrylic acid) layer, the buffer layer is filled between the connecting layer and the protective layer, the amorphous carbon material layer is connected to the hollow carbon sphere of the buffer layer via a covalent bond (carbon-nitrogen bond).

The anode material has a median particle diameter of 2.5 μm, a specific surface area of 5 m²/g, a powder tap density of 0.9 g/cm³, a powder compaction density of 1.65 g/cm³, a mass content of oxygen element in the anode material is 5%, the mass content of carbon element in the anode material is 25%, the thickness of the connecting layer is 50 nm, the thickness of the buffer layer is 500 nm, the thickness of the protective layer is 30 nm, and the mass content of the protective layer in the anode material is 5%.

FIG. 4 is a scanning electron microscope image of the anode material of this example; it can be seen that the surface of the anode material exhibits a spherical carbon structure and a dense carbon layer was surrounded thereon.

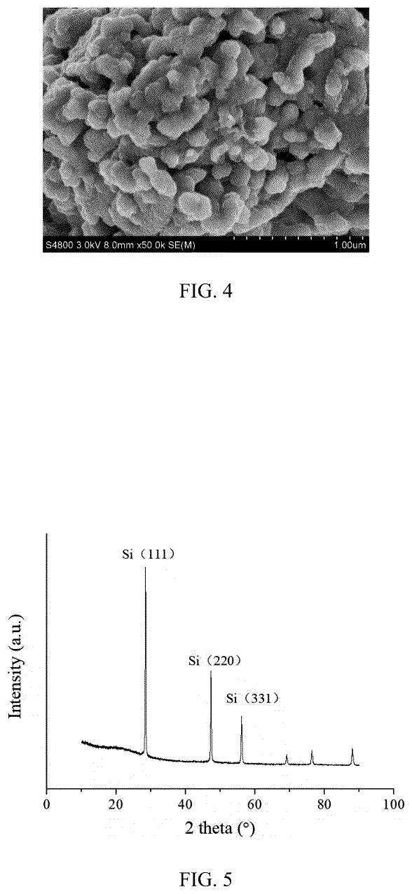

FIG. 5 is a XRD diagram of the anode material of this example; it can be seen from the XRD diagram of the anode material as shown in FIG. 5, three strong peaks at 28.4°, 47.3° and 56.1° correspond to three strong peaks of silicon (JCPDS No. 27-1402), and there is basically no impurity phase.

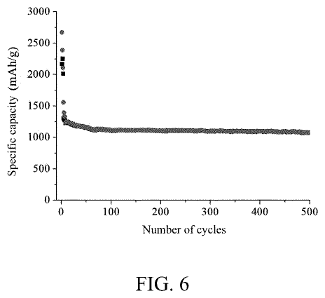

FIG. 6 is a cyclic performance curve image of the anode material of this example; as shown in FIG. 6, the material obtained has excellent cycle performance, the charging and discharging current is 1000 mA/g, there is still a capacity of 1068 mAh/g after 500 cycles at 0.25C and the capacity retention rate reaches 81%.

### Example 2

A method for preparing an anode material includes following steps.
(1) A silicon with a median particle diameter of 2.5 μm was added into a rotation atmosphere furnace, and heated under the protection of argon atmosphere to 950° C. at a heating rate of 3° C./min, and then acetylene was introduced in 0.5 L/min until the volume ratio of the argon to the acetylene in the rotation atmosphere furnace was 9:1, heat-preserved for 4 h before turn off the acetylene. H₂S was then introduced in 1.5 L/min until the volume ratio of the argon to the H₂S in the rotation atmosphere furnace was 5:1, and then heat-preserved for 3 h, cooled down to obtain a composite. 10 g of the composite and cetyl trimethyl ammonium bromide in a mass ratio of 10:1 were dispersed in 200 ml deionized water, stirred for 30 minutes and sonicated for 10 minutes, centrifuged and dried to obtain a first precursor.
(2) 1 g hollow carbon sphere with a diameter of 200 nm and 2 g polydiallyl dimethylammonium chloride were dissolved in 100 ml deionized water, stirred for 30 minutes and sonicated for 20 minutes, and centrifuged and dried to obtain a hollow carbon sphere material with a carboxylated surface. 10 g of the first precursor was dissolved in 100 ml deionized water, stirred for 10 minutes to obtain a solution E and 2 g modified hollow carbon sphere was dispersed in 100 ml deionized water, stirred for 10 minutes to obtain a solution F. The solution E was dropped in to the solution F slowly, stirred for 40 minutes continuously and quickly, centrifuged and dried to obtain a second precursor.
(3) 10 g of the second precursor was taken and dissolved in 100 g deionized water, 1 g polyacrylonitrile was added and then stirred mechanically for 30 minutes, spray dried by controlling the drying temperature at 120° C., finally the anode material was obtained.

The anode material prepared by this example has a core-shell structure, in which the core includes silicon, the shell includes a connecting layer, a buffer layer and a protective layer, the connecting layer is an amorphous carbon material layer, and the amorphous carbon material layer is coated on the surface of the silicon particular, the buffer layer includes the hollow carbon sphere, the protective layer is a polymer layer (polyacrylonitrile), the buffer layer is filled between the connecting layer and the protective layer, the amorphous carbon material layer is connected to the hollow carbon sphere of the buffer layer via a covalent bond (carbon-sulfur bond).

The tests show that the obtained anode material has a median particle diameter of 2.8 μm, a specific surface area of 2 m²/g, a powder tap density of 1.0 g/cm³, a powder compaction density of 1.5 g/cm³, the mass content of oxygen element in the anode material is 4%, the mass content of carbon element in the anode material is 30%, the thickness of the connecting layer is 60 nm, the thickness of the buffer layer is 800 nm, the thickness of the protective layer is 20 nm, and the mass content of the protective layer in the anode material is 8%.

### Example 3

(1) A silicon with a median particle diameter of 2.5 μm was added into a rotation atmosphere furnace, and heated under the protection of argon atmosphere to 950° C. at a heating rate of 3° C./min, and then acetylene was introduced in 0.5 L/min until the volume ratio of the argon to the acetylene in the rotation atmosphere furnace was 9:1, heat-preserved for 4 h before turn off the acetylene. Hydrogen chloride was then introduced in 2.5 L/min until the volume ratio of the argon to the hydrogen chloride in the rotation atmosphere furnace was 8:1, and then heat-preserved for 4 h, cooled down to obtain a composite. 10 g of the composite and polyvinylpyrrolidone in a mass ratio of 10:3 were dispersed in 200 ml anhydrous ethanol, stirred for 30 minutes and sonicated for 10 minutes, centrifuged and dried to obtain a first precursor.
(2) 1 g hollow carbon tube (with a diameter of 50 nm and a length of 1000 nm) and 2 g aminopropyl triethoxysilane were dissolved in 100 ml deionized water, stirred for 30 minutes and sonicated for 20 minutes, and centrifuged and dried to obtain a hollow carbon tube material with amino groups. 10 g of the first precursor was dissolved in 100 ml deionized water, stirred for 10 minutes to obtain a solution E and 2 g modified hollow carbon tube was dispersed in 100 ml deionized water, stirred for 10 minutes to obtain a solution F. The solution E was dropped in to the solution F slowly, stirred for 40 minutes continuously and quickly, centrifuged and dried to obtain a second precursor.
(3) 10 g of the second precursor was taken and dissolved in 100 g anhydrous ethanol, 3 g tannic acid was added and then stirred mechanically for 30 minutes, spray dried by controlling the drying temperature at 120° C., finally the anode material was obtained.

The anode material prepared by this example has a core-shell structure, in which the core includes silicon, the shell includes a connecting layer, a buffer layer and a protective layer, the connecting layer is an amorphous carbon material layer, and the amorphous carbon material layer is coated on the surface of the silicon particular, the buffer layer includes the hollow carbon tube, the protective layer is a polymer layer (polytannic acid), the buffer layer is filled between the connecting layer and the protective layer, the amorphous carbon material layer is connected to the hollow carbon tube of the buffer layer via a covalent bond (carbon-chloride bond).

The anode material prepared by this example has a core-shell structure, in which the core includes silicon, the shell includes a connecting layer and a protective layer, the connecting layer is an amorphous carbon material layer, and the protective layer includes polytannic acid and the hollow carbon tube dispersed in the polytannic acid.

The tests show that the anode material has a median particle diameter of 4.5 μm, a specific surface area of 8 m²/g, a powder tap density of 1.1 g/cm³, a powder compaction density of 1.7 g/cm³, the mass content of oxygen element in the anode material is 7%, the mass content of carbon element in the anode material is 35%, the thickness of the connecting layer is 60 nm, the thickness of the buffer layer is 700 nm, the thickness of the protective layer is 45 nm, and the mass content of the protective layer in the anode material is 15%.

### Example 4

(1) A silicon with a median particle diameter of 2 μm was added into a rotation atmosphere furnace, and heated under the protection of argon atmosphere to 900° C. at a heating rate of 3° C./min, and then acetylene was introduced in 0.5 L/min until the volume ratio of the argon to the acetylene in the rotation atmosphere furnace was 9:1, heat-preserved for 3 h before turn off the acetylene. Ammonia was then introduced in 1.5 L/min until the volume ratio of the argon to the ammonia in the rotation atmosphere furnace was 4:1, and then heat-preserved for 3 h before turn off the ammonia, cooled down to obtain a first precursor.
(2) 10 g of the first precursor and 0.5 g hollow carbon tube (with a diameter of 50 nm and a length of 1000 nm) were dissolved in 200 ml anhydrous ethanol, then 2 g polyvinylpyrrolidone was added, stirred for 30 minutes and sonicated for 10 minutes to obtain a mixed slurry. The mixed slurry was spheroidized by spray granulation under a drying condition of 130° C. to obtain a second precursor.
(3) 10 g of the second precursor was taken and dissolved in 100 g anhydrous ethanol, 3 g polyacrylic acid was added and then stirred mechanically for 30 minutes, spray dried by controlling the drying temperature at 100° C., finally the anode material was obtained.

The anode material prepared by this example has a core-shell structure, in which the core includes silicon, the shell includes a connecting layer, a buffer layer and a protective layer, the connecting layer is an amorphous carbon material layer, and the amorphous carbon material layer is coated on the surface of the silicon particular, the buffer layer includes the hollow carbon tube, the protective layer is a polymer (polyacrylic acid) layer, the buffer layer is filled between the connecting layer and the protective layer, the amorphous carbon material layer is connected to the hollow tube of the buffer layer via a covalent bond (carbon-nitrogen bond).

The anode material prepared by this example has a core-shell structure, in which the core includes silicon, the shell includes a connecting layer and a protective layer, the connecting layer is an amorphous carbon material layer, and the protective layer includes polyacrylic acid and the hollow carbon tube dispersed in the polyacrylic acid.

The tests show that the anode material has a median particle diameter of 3.5 μm, a specific surface area of 15 m²/g, a powder tap density of 0.88 g/cm³, a powder compaction density of 1.36 g/cm³, the mass content of oxygen element in the anode material is 11%, the mass content of carbon element in the anode material is 21%, the thickness of the connecting layer is 50 nm, the thickness of the buffer layer is 300 nm, the thickness of the protective layer is 33 nm, and the mass content of the protective layer in the anode material is 5%.

### Example 5

(1) A silicon with a median particle diameter of 3 μm was added into a rotation atmosphere furnace, and heated under the protection of argon atmosphere to 800° C. at a heating rate of 5° C./min, and then acetylene was introduced in 0.5 L/min until the volume ratio of the argon to the acetylene in the rotation atmosphere furnace was 9:1, heat-preserved for 3 h before turn off the acetylene. Ammonia was then introduced in 2.5 L/min until the volume ratio of the argon to the ammonia in the rotation atmosphere furnace was 6:1, and then heat-preserved for 3 h before turn off the ammonia, cooled down to obtain a first precursor.
(2) 10 g of the first precursor and 0.5 g hollow carbon tube (with a diameter of 80 nm and a length of 1100 nm) were dissolved in 200 ml anhydrous ethanol, then 2 g polyvinylpyrrolidone was added, stirred for 30 minutes and sonicated for 10 minutes to obtain a mixed slurry. The mixed slurry was spheroidized by spray granulation under a drying condition of 130° C. to obtain a second precursor.
(3) 10 g of the second precursor was taken and dissolved in 100 g anhydrous ethanol, 1 g polyacrylonitrile acid was added and then stirred mechanically for 30 minutes, spray dried by controlling the drying temperature at 100° C., finally the anode material was obtained.

The anode material prepared by this example has a core-shell structure, in which the core includes silicon, the shell includes a connecting layer, a buffer layer and a protective layer, the connecting layer is an amorphous carbon material layer, and the amorphous carbon material layer is coated on the surface of the silicon particular, the buffer layer includes the hollow carbon tube, the protective layer is a polymer layer (polyacrylonitrile), the buffer layer is filled between the connecting layer and the protective layer, the amorphous carbon material layer is connected to the hollow carbon tube of the buffer layer via a covalent bond (carbon-nitrogen bond).

The anode material prepared by this example has a core-shell structure, in which the core includes silicon, the shell includes a connecting layer and a protective layer, the connecting layer is an amorphous carbon material layer, and the protective layer includes polyacrylonitrile and the hollow carbon tube dispersed in the polyacrylonitrile.

The tests show that the silicon carbon anode material has a median particle diameter of 5 μm, a specific surface area of 19 m²/g, a powder tap density of 0.98 g/cm³, a powder compaction density of 1.4 g/cm³, the mass content of oxygen element in the anode material is 23%, the mass content of carbon element in the anode material is 29%, the thickness of the connecting layer is 66 nm, the thickness of the buffer layer is 200 nm, the thickness of the protective layer is 25 nm, and the mass content of the protective layer in the anode material is 5%.

### Example 6

(1) A silicon with a median particle diameter of 6 μm was added into a rotation atmosphere furnace, and heated under the protection of argon atmosphere to 900° C. at a heating rate of 3° C./min, and then acetylene was introduced in 0.5 L/min until the volume ratio of the argon to the acetylene in the rotation atmosphere furnace was 9:1, heat-preserved for 3 h before turn off the acetylene. Hydrogen fluoride was then introduced in 3.5 L/min until the volume ratio of the argon to the hydrogen fluoridein the rotation atmosphere furnace was 2:1, and then heat-preserved for 8 h before turn off the hydrogen fluoride, cooled down to obtain a first precursor.
(2) 10 g of the first precursor and 0.5 g hydroxylated hollow carbon tube (with a diameter of 50 nm and a length of 1000 nm) were dissolved in 200 ml anhydrous ethanol, then 2 g polyvinylpyrrolidone was added, stirred for 30 minutes and sonicated for 10 minutes to obtain a mixed slurry. The mixed slurry was spheroidized by spray granulation under a drying condition of 130° C. to obtain a second precursor.
(3) 100 g of the second precursor was added into a rotation atmosphere furnace, and heated under the protection of argon atmosphere to 900° C. at a heating rate of 3° C./min, and then methane was introduced in 0.5 L/min until the volume ratio of the argon to the acetylene in the rotation atmosphere furnace was 9:1, heat-preserved for 6 h before turn off the methane, cooled down to obtain the anode material.

The anode material prepared by this example has a core-shell structure, in which the core includes silicon, the shell includes a connecting layer and a protective layer, the connecting layer is an amorphous carbon material layer and coated on the surface of the silicon particular; the protective layer includes amorphous carbon material and the hollow carbon tube dispersed in the amorphous carbon material. The amorphous carbon material layer is connected to the hollow carbon tube via a covalent bond (carbon-fluorine bond).

The anode material has a median particle diameter of 8 μm, a specific surface area of 11 m²/g, a powder tap density of 0.98 g/cm³, a powder compaction density of 1.3 g/cm³, the mass content of oxygen element in the anode material is 8%, the mass content of carbon element in the anode material is 32%, the thickness of the connecting layer is 50 nm, the thickness of the protective layer is 350 nm, and the mass content of the protective layer in the anode material is 14%.

### Example 7

Steps for preparing an anode material of this example are roughly the same as that of example 1, the only difference from example 1 lies in that step (1) of this example includes no modification operation with ammonia. Specifically, step (1) of this example is conducted as follows:

A silicon with a median particle diameter of 6 μm was added into a rotation atmosphere furnace, and heated under the protection of argon atmosphere to 900° C. at a heating rate of 3° C./min, and then acetylene was introduced in 0.5 L/min until the volume ratio of the argon to the acetylene in the rotation atmosphere furnace was 9:1, heat-preserved for 3 h before turn off the acetylene, cooled down to obtain a composite. 10 g of the composite and cetyl trimethyl ammonium bromide in a mass ratio of 10:2 were dispersed in 200 ml deionized water, stirred for 30 minutes and sonicated for 10 minutes, centrifuged and dried to obtain a dried product which was then placed in a vacuum reactor, heated to 700° C. and heat-preserved for 3 h to obtain a first precursor with amination modification on the surface.

The anode material prepared by this example has a core-shell structure, in which the core includes silicon, the shell includes a connecting layer, a buffer layer and a protective layer, the connecting layer is an amorphous carbon material layer, and the amorphous carbon material layer is coated on the surface of the silicon particular, the buffer layer includes the hollow carbon sphere, the protective layer is a polymer (polyacrylic acid) layer, the buffer layer is filled between the connecting layer and the protective layer, the amorphous carbon material layer is connected to the hollow carbon sphere of the buffer layer via a covalent bond (carbon-nitrogen bond).

The anode material has a median particle diameter of 2.2 μm, a specific surface area of 4.8 m²/g, a powder tap density of 0.92 g/cm³, a powder compaction density of 1.59 g/cm³, the mass content of oxygen element in the anode material is 7%, the mass content of carbon element in the anode material is 23%, the thickness of the connecting layer is 60 nm, the thickness of the buffer layer is 550 nm, the thickness of the protective layer is 50 nm, and the mass content of the protective layer in the anode material is 5.2%.

### Example 8

Steps for preparing an anode material of this example are roughly the same as that of example 1, the only difference from example 1 lies in that SiO is used as a silicon-based active material in this example.

The anode material prepared by this example has a core-shell structure, in which the core includes SiO, the shell includes a connecting layer, a buffer layer and a protective layer, the connecting layer is an amorphous carbon material layer, and the amorphous carbon material layer is coated on the surface of the silicon particular, the buffer layer includes the hollow carbon sphere, the protective layer is a polymer (polyacrylic acid) layer, the buffer layer is filled between the connecting layer and the protective layer, the amorphous carbon material layer is connected to the hollow carbon sphere of the buffer layer via a covalent bond (carbon-nitrogen bond).

The anode material has a median particle diameter of 2.6 μm, a specific surface area of 5.3 m²/g, a powder tap density of 0.97 g/cm³, a powder compaction density of 1.64 g/cm³, the mass content of oxygen element in the anode material is 19%, the mass content of carbon element in the anode material is 22%, the thickness of the connecting layer is 54 nm, the thickness of the buffer layer is 500 nm, the thickness of the protective layer is 40 nm, and the mass content of the protective layer in the anode material is 8%.

### Example 9

Steps for preparing an anode material of this example are roughly the same as that of example 1, the only difference from example 1 lies in that lithium silicon alloy is used as a silicon-based active material in this example.

The anode material prepared by this example has a core-shell structure, in which the core includes lithium silicon alloy, the shell includes a connecting layer, a buffer layer and a protective layer, the connecting layer is an amorphous carbon material layer, and the amorphous carbon material layer is coated on the surface of the silicon particular, the buffer layer includes the hollow carbon sphere, the protective layer is a polymer (polyacrylic acid) layer, the buffer layer is filled between the connecting layer and the protective layer, the amorphous carbon material layer is connected to the hollow carbon sphere of the buffer layer via a covalent bond (carbon-nitrogen bond).

The median particle diameter of the anode material is 3.1 μm, the specific surface area thereof is 6.1 m²/g, the powder tap density is 1.01 g/cm³, the powder compaction density is 1.72 g/cm³, the mass content of oxygen element in the anode material is 12%, the mass content of carbon element in the anode material is 28%, the thickness of the connecting layer is 50 nm, the thickness of the buffer layer is 600 nm, the thickness of the protective layer is 60 nm, and the mass content of the protective layer in the anode material is 8.5%.

### Example 10

(1) A silicon with a median particle diameter of 6 μm was placed in 1 mol/L nickel acetate solution, sonicated for 30 minutes to obtain a dispersion solution. The dispersion solution was then dried through spray drying to obtain a silicon precursor with nickel acetate modified surface. The silicon precursor was added into a rotation atmosphere furnace, and heated under the protection of argon atmosphere to 900° C. at a heating rate of 3° C./min, and then toluene vapor was introduced in 0.5 L/min and ammonia was introduced in 1.5 L/min until the volume ratio of the argon to the toluene in the rotation atmosphere furnace was 9:1, heat-preserved for 3 h before turn off the ammonia, cooled down to obtain a composite. 10 g of the composite and cetyl trimethyl ammonium bromide were dispersed in 200 ml deionized water in a mass ratio of 10:2, stirred for 30 minutes and sonicated for 10 minutes, centrifuged and dried to obtain a first precursor.
(2) 1 g hollow carbon sphere with a diameter of 100 nm and 1 g polydiallyl dimethylammonium chloride were dissolved in 100 ml deionized water, stirred for 30 minutes and sonicated for 20 minutes, and centrifuged and dried to obtain a hollow carbon sphere material with a hydroxylated surface. 10 g of the first precursor was dissolved in 100 ml deionized water, stirred for 10 minutes to obtain a solution E and 1 g modified hollow carbon sphere was dispersed in 100 ml deionized water, stirred for 10 minutes to obtain a solution F. The solution E was dropped into the solution F slowly, stirred for 40 minutes continuously and quickly, centrifuged and dried to obtain a second precursor.
(3) 10 g of the second precursor was taken and dissolved in 100 g anhydrous ethanol, 1 g polyacrylic acid was added and then stirred mechanically for 30 minutes, spray dried by controlling the drying temperature at 100° C., finally the anode material was obtained.

The anode material prepared by this example has a core-shell structure, in which the core includes silicon, the shell includes a connecting layer, a buffer layer and a protective layer, the connecting layer is a graphitized carbon material layer, in which the graphitized carbon material includes graphene and the graphitized carbon material layer is coated on the surface of the silicon particular, the buffer layer includes the hollow carbon sphere, the protective layer is a polymer (polyacrylic acid) layer, the buffer layer is filled between the connecting layer and the protective layer, the graphitized carbon material layer is connected to the hollow carbon sphere of the buffer layer via a covalent bond (carbon-nitrogen bond).

The anode material has a median particle diameter of 2.4 μm, a specific surface area of 5.6 m²/g, a powder tap density of 0.88 g/cm³, a powder compaction density of 1.63 g/cm³, the mass content of oxygen element in the anode material is 4.6%, the mass content of carbon element in the anode material is 22%, the thickness of the connecting layer is 5 nm, the thickness of the buffer layer is 500 nm, the thickness of the protective layer is 30 nm, and the mass content of the protective layer in the anode material is 5%.

### Example 11

(1) A silicon with a median particle diameter of 6 μm was placed in a 1 mol/L solution of tri-block copolymer P123 (polyethylene oxide-polypropylene oxide-polyethylene oxide), the mass ratio of the silicon and the polymer was 10:1. The mixture was sonicated for 60 minutes to obtain a mixed coating liquid, the solid content in the mixed coating liquid was 40%. The mixed coating liquid was then dried through spray drying to obtain a first precursor, and the first precursor includes silicon and a connecting layer coated on the surface of the silicon. The polyethylene oxide-polypropylene oxide-polyethylene oxide per se used in this step contains a modified functional group, for example phenolic hydroxyl, carboxyl, and carbonyl.
(2) 1 g hollow carbon sphere with a diameter of 100 nm and 1 g polydiallyl dimethylammonium chloride were dissolved in 100 ml deionized water, stirred for 30 minutes and sonicated for 20 minutes, and centrifuged and dried to obtain a hollow carbon sphere material with a hydroxylated surface. 10 g of the first precursor was dissolved in 100 ml deionized water, stirred for 10 minutes to obtain a solution E and 1 g modified hollow carbon sphere was dispersed in 100 ml deionized water, stirred for 10 minutes to obtain a solution F. The solution E was dropped into the solution F slowly, stirred for 40 minutes continuously and quickly, centrifuged and dried to obtain a second precursor.
(3) 10 g of the second precursor was dissolved in 100 g anhydrous ethanol, 1 g polyacrylic acid was added and then stirred mechanically for 30 minutes, spray dried by controlling the drying temperature at 100° C., finally the anode material was obtained.

The anode material prepared by this example has a core-shell structure, in which the core includes silicon, the shell includes a connecting layer, a buffer layer and a protective layer, the connecting layer is a polymer layer, the polymer layer is coated on the surface of the silicon particular, the buffer layer includes the hollow carbon sphere, the protective layer is a polymer (polyacrylic acid) layer, the buffer layer is filled between the connecting layer and the protective layer, the polymer layer is connected to the hollow carbon sphere of the buffer layer via a covalent bond (carbon-oxygen bond).

The anode material prepared by this example has a core-shell structure, in which the core includes silicon, the shell includes a connecting layer and a protective layer, the connecting layer is a polymer layer, and the protective layer includes polyacrylic acid and the hollow carbon sphere dispersed in the polyacrylic acid.

The anode material has a median particle diameter of 2.6 μm, a specific surface area of 5.7 m²/g, a powder tap density of 0.89 g/cm³, a powder compaction density of 1.61 g/cm³, the mass content of oxygen element in the anode material is 4.9%, the mass content of carbon element in the anode material is 27%, the thickness of the connecting layer is 20 nm, the thickness of the buffer layer is 500 nm, the thickness of the protective layer is 30 nm, and the mass content of the protective layer in the anode material is 5%.

### Comparative Example 1

(1) 10 g of silicon material with a median particle diameter of 2 μm and cetyl trimethyl ammonium bromide in a mass ratio of 10:2 were dispersed in 200 ml deionized water, stirred for 30 minutes and sonicated for 10 minutes, centrifuged and dried to obtain a modified silicon material. 1 g hollow carbon sphere with a diameter of 100 nm and 1 g polydiallyl dimethylammonium chloride were dissolved in 100 ml deionized water, stirred for 30 minutes and sonicated for 20 minutes, and centrifuged and dried to obtain a modified hollow carbon sphere material. 10 g of the modified silicon material was dissolved in 100 ml deionized water, stirred for 10 minutes to obtain a solution E1 and 1 g modified hollow carbon sphere was dispersed in 100 ml deionized water, stirred for 10 minutes to obtain a solution F1. The solution E1 was dropped into the solution F1 slowly, stirred for 40 minutes continuously and quickly, centrifuged and dried to obtain a composite product H1.
(2) 10 g of the composite product H1 was taken and dissolved in 100 g anhydrous ethanol, 1 g polyacrylic acid was added and then stirred mechanically for 30 minutes, spray dried by controlling the drying temperature at 100° C., finally the anode material was obtained.

The anode material prepared by this example includes monatomic silicon, a buffer layer and a protective layer coated on the surface of the monatomic silicon, the buffer layer is hollow carbon sphere, the protective layer is polypropylene, and no connecting layer on the surface of the monatomic silicon.

The tests show that the anode material has a median particle diameter of 2.2 μm, a specific surface area of 8.5 m²/g, a powder tap density of 0.8 g/cm³, a powder compaction density of 1.1 g/cm³, the mass content of oxygen element in the anode material is 25%, the mass content of carbon element in the anode material is 15%, the thickness of the buffer layer is 500 nm, and the mass content of the protective layer in the anode material is 3%.

### Comparative Example 2

(1) A silicon with a median particle diameter of 2 μm was added into a rotation atmosphere furnace, and heated under the protection of argon atmosphere to 900° C. at a heating rate of 3° C./min, and then acetylene was introduced in 0.5 L/min until the volume ratio of the argon to the acetylene in the rotation atmosphere furnace was 9:1, heat-preserved for 3 h before turn off the acetylene, the first precursor was obtained.
(2) 10 g of the first precursor was dissolved in 100 ml deionized water, stirred for 10 minutes to obtain a solution E, and 1 g hollow carbon sphere was dispersed in 100 ml deionized water, stirred for 10 minutes to obtain a solution F. The solution E was dropped into the solution F slowly, stirred for 40 minutes quickly, centrifuged and dried to obtain a second precursor.
(3) 10 g of the second precursor was dissolved in 100 g anhydrous ethanol, 1 g polyacrylic acid was added and then stirred mechanically for 30 minutes, spray dried by controlling the drying temperature at 100° C., finally the anode material was obtained.

The anode material prepared by this example has a core-shell structure, in which the core includes silicon, the shell includes a connecting layer, a buffer layer and a protective layer, the connecting layer is an amorphous carbon material layer, and the amorphous carbon material layer is coated on the surface of the silicon particular, the buffer layer includes the hollow carbon sphere, the protective layer is a polymer (polyacrylic acid) layer, the buffer layer is filled between the connecting layer and the protective layer.

The anode material has a median particle diameter of 2.9 μm, a specific surface area of 9 m²/g, a powder tap density of 0.8 g/cm³, a powder compaction density of 1.5 g/cm³, the mass content of oxygen element in the anode material is 12%, the mass content of carbon element in the anode material is 20%, the thickness of the connecting layer is 10 nm, the thickness of the buffer layer is 400 nm, the thickness of the protective layer is 40 nm, and the mass content of the protective layer in the anode material is 22%.

### Test Methods

### 1) Median Particle Diameter of Anode Material

The method for testing the median particle diameter refers to GB/T 19077-2016. The median particle diameter can be conveniently measured by laser particle size analyzer such as Mastersizer 3000 type laser particle size analyzer supplied by Malvery Instruments Ltd.

### 2) Test Method for the Specific Surface Area of the Anode Material

At a constant low temperature, after measuring the adsorption amount of gas on solid surface at different relative pressures, the adsorption amount of monomolecular layer of the sample is calculated based on the Brunauer-Emmelt-Teller adsorption theory and its formula (BET formula), so that the specific surface area of the material is calculated.

### 3) Test Method for the Tap Density

A BT tap density tester is used. A certain amount of samples is weighed, and the tap density is tested with vibrating 3000 times in 300 times/min.

### 4) Test Methods for the Oxygen Content and Carbon Content

The oxygen content is measured with a Fourier infrared spectrometer, and the carbon content is measured with thermogravimetric analysis.

### 5) Test Methods for the Size of the Hollow Carbon Material

The size of the hollow carbon material is measured by an Atomic Force Microscope (AFM) and a high-resolution transmission electron microscope (HRTEM).

### 6) Test Method of the Thickness of the Connecting Layer and the Protective Layer

The material is cut by a FIB-SEM device, and then the average thickness of the connecting layer and the protective layer was measured in SEM.

7) Test Method for the Binding Force between the Hollow Carbon Material and the Connecting Layer

A required maximum pulling force (F) for detaching a single hollow carbon material from the connecting layer is measured by a nano mechanical test system and a probe test system. In the examples of the present disclosure and comparative examples, bonding forces at five positions were measured and an average value was calculated.

The anode materials (corresponding to sample numbers of S1-S11 and R1-R2) prepared in Examples 1-11 and Comparative Examples 1-2 were tested by the above test methods, and the tested performance parameters of these anode materials were shown in Table 1.

TABLE 1
Performance Parameters of the Anode Material

| Performance | | | | | | | | | | | | | |
|---|---|---|---|---|---|---|---|---|---|---|---|---|---|
| parameters | S1 | S2 | S3 | S4 | S5 | S6 | S7 | S8 | S9 | S10 | S11 | R1 | R2 |
| Median | 2.5 | 2.8 | 4.5 | 3.5 | 5 | 8 | 2.2 | 2.6 | 3.1 | 2.4 | 2.6 | 2.2 | 2.9 |
| particle | | | | | | | | | | | | | |
| diameter | | | | | | | | | | | | | |
| (D50, μm) | | | | | | | | | | | | | |
| Specific | 5 | 2 | 8 | 15 | 19 | 11 | 4.8 | 5.3 | 6.1 | 5.6 | 5.7 | 8.5 | 9 |
| surface area | | | | | | | | | | | | | |
| (m2/g) | | | | | | | | | | | | | |
| Tap density | 0.9 | 1.0 | 1.1 | 0.88 | 0.98 | 0.98 | 0.92 | 0.97 | 1.01 | 0.88 | 0.89 | 0.8 | 0.8 |
| (g/cm³) | | | | | | | | | | | | | |
| Compaction | 1.65 | 1.5 | 1.7 | 1.36 | 1.4 | 1.3 | 1.59 | 1.64 | 1.72 | 1.63 | 1.61 | 1.2 | 1.5 |
| density | | | | | | | | | | | | | |
| (g/cm³) | | | | | | | | | | | | | |
| Content of | 5 | 4 | 7 | 11 | 23 | 8 | 7 | 19 | 12 | 4.6 | 4.9 | 25 | 12 |
| oxygen (%) | | | | | | | | | | | | | |
| Content of | 25 | 30 | 35 | 21 | 29 | 32 | 23 | 22 | 28 | 22 | 27 | 15 | 20 |
| carbon (%) | | | | | | | | | | | | | |
| Thickness of | 50 | 60 | 60 | 50 | 66 | 50 | 60 | 54 | 50 | 5 | 20 | 0 | 10 |
| the connecting | | | | | | | | | | | | | |
| layer (nm) | | | | | | | | | | | | | |
| Thickness of | 500 | 800 | 700 | 300 | 200 | / | 550 | 500 | 600 | 500 | 500 | 500 | 400 |
| the buffer | | | | | | | | | | | | | |
| layer (nm) | | | | | | | | | | | | | |
| Thickness of | 30 | 20 | 45 | 33 | 25 | 350 | 50 | 40 | 60 | 30 | 30 | 23 | 40 |
| the protective | | | | | | | | | | | | | |
| layer (nm) | | | | | | | | | | | | | |
| Binding force | 17.1 | 8.6 | 11.8 | 9.9 | 12 | 10 | 15.6 | 15 | 16.4 | 15.8 | 14.2 | / | 1.3 |
| between the | | | | | | | | | | | | | |
| hollow carbon | | | | | | | | | | | | | |
| material and | | | | | | | | | | | | | |
| the connecting | | | | | | | | | | | | | |
| layer (μN) | | | | | | | | | | | | | |

### 9) Electrochemical Test

A slurry was prepared by mixing the anode material with sodium carboxymethyl cellulose, styrene-butadiene rubber, conductive graphite (KS-6) and carbon black (SP) in a ratio of 92:2:2:2:2, and was uniformly coated on copper foil and dried to obtain an anode plate. The anode plate was assembled into a coin cell in an argon atmosphere glove box. A diaphragm used was a polypropylene microporous membrane, and the electrolyte used was 1 mol/L lithium hexafluorophosphate (solvent is a mixed slurry of ethylene carbonate, methyl ethyl carbonate and dimethyl carbonate with a volume ratio of 1:1:1), a counter electrode used was a metal lithium plate.

The discharge specific capacity was tested on above 13 groups of batteries through a LAND CT2001A battery test system. When discharging from an open circuit voltage to a voltage of 0.01 V at 0.01 C, a specific capacity of the batteries is the discharge specific capacity.

The first coulomb efficiency was tested on the above 13 groups of batteries through a LAND CT2001A battery test system under a charging and discharging current of 0.05C.

The above 13 groups of batteries were tested through the LAND CT2001A battery test system after 100 cycles by using a charging and discharging current of 0.2C, and the battery capacity and the capacity retention rate were tested and calculated after 100 cycles.

The capacity retention rate after 100 cycles at 0.2C=the discharge capacity at the 100th cycle/the discharge capacity at the third cycle×100%.

The expansion rate of electrode membrane after 100 cycles at 0.2C=(thickness of the electrode film after the 100th cycle-the initial thickness of the electrode film)/the initial thickness of the electrode film×100%. The results are shown in Table 2.

TABLE 2
Table of comparison of performance parameters for batteries

| | | | | Capacity | |
|---|---|---|---|---|---|
| | | | Capacity | retention | Expansion |
| | Specific | Initial | after 100 | rate after | rate of |
| | discharge | coulombic | cycles at | 100 cycles | electrode |
| | capacity | efficiency | 0.2 C | at 0.2 C | membrane |
| Sample | (mAh/g) | (%) | (mAh/g) | (%) | (%) |
| S1 | 2890 | 89.1 | 1068 | 81 | 23.4 |
| S2 | 2700 | 86.6 | 990 | 75.4 | 24.7 |
| S3 | 2450 | 84.7 | 1005 | 72.5 | 26.6 |
| S4 | 2130 | 83.1 | 974 | 78.6 | 24.5 |
| S5 | 2340 | 83.4 | 955 | 80.1 | 33.6 |
| S6 | 2258 | 82 | 943 | 79.5 | 32 |
| S7 | 2144 | 79 | 780 | 68 | 31 |
| S8 | 1570 | 77 | 890 | 80 | 23 |
| S9 | 1522 | 79 | 650 | 78 | 23 |
| S10 | 2478 | 85 | 923 | 77 | 26 |
| S11 | 2356 | 86 | 977 | 79 | 27 |
| R1 | 1560 | 79.5 | 708 | 61.5 | 35.1 |
| R2 | 2107 | 76 | 760 | 66 | 45 |

The anode material of the present disclosure has advantages of low expansion and excellent cycle stability.

As shown in table 2, in the anode materials prepared in examples 1 to 11, by forming a connecting layer with a modified functional group on the surface of a silicon-based active material, and then conducting polymerization reaction between the hollow carbon material with functional groups and a first precursor, the connecting layer was covalently connected to the hollow carbon material, so that the bonding strength between the connecting layer and the hollow carbon material can be enhanced greatly, and excellent electric contact between the connecting layer and the buffer layer can be ensured after volumetric expansion of the silicon-based active material. In addition, a protective layer formed can further improve the conductivity and structure integrity of the anode material, and effectively inhibit side reactions due to contact between the anode material and the electrolyte. It is beneficial to the anode material to maintain excellent mechanical properties, improve the structural stability of the anode material, and further improve the cycle stability of the anode material.

During the preparation process of the anode material of the Comparative Example 1, no connecting layer is formed on the surface of the silicon simple substance, and the hollow carbon sphere is attached on the surface of the silicon particles, resulting in reduction of the connection stability. During the cycle process, the expansion stress of silicon particles leads to the disconnection between the hollow carbon sphere and the silicon particle, so that the electrical contact between the hollow carbon sphere and the silicon particle is reduced, the capacity retention rate of the anode material is reduced, and the expansion rate of the anode material is significantly increased.

During the preparation process of the anode material of the Comparative Example 2, no modifying treatment is conducted on the connecting layer, and thus the hollow carbon material and the connecting layer cannot be connected through a covalent bond, but they are connected by intermolecular forces, resulting in reduction of the connection stability. During the cycle process, the expansion stress of silicon particles leads to the disconnection between the hollow carbon sphere and the silicon particle, so that the electrical contact between the hollow carbon sphere and the silicon particle is reduced, the capacity retention rate of the anode material is reduced, and the expansion rate of the anode material is significantly increased.

Although the present disclosure discloses the preferred embodiments as above, it is not intended to limit the claims. A person skilled in the art can make many possible changes and modifications without departing from the concept of the present disclosure. Therefore, the protection scope of the present disclosure shall be defined by the scope of the claims in the present disclosure.

1. An anode material, wherein the anode material has a core-shell structure, wherein the core comprises a silicon-based active material, the shell comprises a connecting layer, a buffer layer and a protective layer, the connecting layer is coated on the surface of the silicon-based active material, the buffer layer is filled between the connecting layer and the protective layer, and the connecting layer is connected to the buffer layer via a covalent bond.

2. The anode material according to claim 1, wherein the covalent bond comprises a carbon-carbon bond, a carbon-oxygen bond, a carbon-nitrogen bond, a carbon-sulfur bond, a carbon-chlorine bond, a fluoro-carbon bond, a nitrogen-oxygen bond, an oxygen-sulfur bond, an oxygen-chlorine bond and a nitrogen-sulfur bond.

3. An anode material, wherein the anode material has a core-shell structure, wherein a core comprises a silicon-based active material, a shell comprises a connecting layer, a buffer layer and a protective layer, the connecting layer is coated on the surface of the silicon-based active material, the buffer layer is filled between the connecting layer and the protective layer, and an average bonding force F between the connecting layer and the buffer layer is >8μ N.

4. The anode material according to claim 1, wherein the anode material comprises at least one of following features (1) to (24):
(1) the connecting layer comprises at least one of a polymer, an amorphous carbon material and a graphitized carbon material;
(2) the buffer layer comprises a hollow carbon material;
(3) the buffer layer comprises a hollow carbon material, and the hollow carbon material comprises at least one of hollow carbon sphere, hollow carbon rod and hollow carbon tube;
(4) the buffer layer comprises a hollow carbon material, the hollow carbon material comprises a hollow carbon sphere, and a diameter of the hollow carbon sphere is 20 nm to 2000 nm;
(5) the buffer layer comprises a hollow carbon material, the hollow carbon material comprises a hollow carbon sphere, and a wall thickness of the hollow carbon sphere is 5 nm to 500 nm;
(6) the buffer layer comprises a hollow carbon material, the hollow carbon material comprises a hollow carbon rod, and a diameter of the hollow carbon rod is 10 nm to 1000 nm;
(7) the buffer layer comprises a hollow carbon material, the hollow carbon material comprises a hollow carbon rod, and a length of the hollow carbon rod is 100 nm to 3000 nm;
(8) the buffer layer comprises a hollow carbon material, the hollow carbon material comprises a hollow carbon rod, and a wall thickness of the hollow carbon rod is 5 nm to 500 nm;
(9) the buffer layer comprises a hollow carbon material, the hollow carbon material comprises a hollow carbon tube, and a length of the hollow carbon tube is 30 nm to 20 μm;
(10) the buffer layer comprises a hollow carbon material, the hollow carbon material comprises a hollow carbon tube, and a wall thickness of the hollow carbon tube is 5 nm to 100 nm;
(11) the buffer layer comprises a hollow carbon material, the hollow carbon material comprises a hollow carbon tube, and a diameter of the hollow carbon tube is 20 nm to 400 nm;
(12) a ratio of a thickness of the buffer layer and a median particle diameter D50 of the silica-based active material is 1:(0.5-10);
(13) the protective layer is coated on a surface of the buffer layer;
(14) the buffer layer comprises a hollow carbon material, and at least part of the protective layer is filled in a gap of the hollow carbon material;
(15) the protective layer comprises at least one of a polymer, an amorphous carbon material and a graphitized carbon material;
(16) a thickness of the connecting layer is 5 nm to 200 nm;
(17) a thickness of the protective layer is 5 nm to 500 nm;
(18) the protective layer comprises a graphitized carbon material, and the graphitized carbon material is a doping element-containing modified grapheme;
(19) the protective layer comprises a graphitized carbon material, the graphitized carbon material is a doping element-containing modified grapheme, and a number of layers of the modified graphene is <10;
(20) the protective layer comprises a graphitized carbon material, the graphitized carbon material is a doping element-containing modified grapheme, and the doping element comprises at least one of oxygen, nitrogen and sulphur;
(21) the protective layer comprises a graphitized carbon material, the graphitized carbon material is a doping element-containing modified grapheme, and the mass content of the doping element in the graphitized carbon material is 1% to 20%;
(22) the protective layer comprises a polymer, and the polymer comprises at least one of a double-block copolymer, a tri-block copolymer and a multi-block copolymer;
(23) the protective layer comprises a polymer, the mass content of the polymer in the anode material is 1% to 20%; or
(24) the protective layer comprises a polymer, the polymer comprises at least one of polyacrylic acid, polyacrylonitrile, polyimide, polyurethane, polydopamine, xanthan gum, polypyrrole, polythiophene, polyphenylacetylene, polyaniline, polyacetylene and tannic acid.

5. An anode material, wherein the anode material has a core-shell structure, wherein a core comprises a silicon-based active material, a shell comprises a connecting layer and a protective layer, the connecting layer is coated on the surface of the silicon-based active material, the protective layer comprises a conductive substrate and a hollow carbon material dispersed in the conductive substrate, wherein an average bonding force F between the connecting layer and the hollow carbon material is >8 μN.

6. The anode material according to claim 5, wherein the anode material comprises at least one of following features (1) to (21):
(1) the connecting layer comprises at least one of a polymer, an amorphous carbon material and a graphitized carbon material;
(2) the hollow carbon material comprises at least one of hollow carbon sphere, hollow carbon rod and hollow carbon tube;
(3) the hollow carbon material comprises a hollow carbon sphere, and a diameter of the hollow carbon sphere is 20 nm to 2000 nm;
(4) the hollow carbon material comprises a hollow carbon sphere, and a wall thickness of the hollow carbon sphere is 5 nm to 500 nm;
(5) the hollow carbon material comprises a hollow carbon rod, and a diameter of the hollow carbon rod is 10 nm to 1000 nm;
(6) the hollow carbon material comprises a hollow carbon rod, and a length of the hollow carbon rod is 100 nm to 3000 nm;
(7) the hollow carbon material comprises a hollow carbon rod, and a wall thickness of the hollow carbon rod is 5 nm to 500 nm;
(8) the hollow carbon material comprises a hollow carbon tube, and a length of the hollow carbon tube is 30 nm to 20 μm;
(9) the hollow carbon material comprises a hollow carbon tube, and a wall thickness of the hollow carbon tube is 5 nm to 100 nm;
(10) the hollow carbon material comprises a hollow carbon tube, and a diameter of the hollow carbon tube is 20 nm to 400 nm;
(11) the protective layer is coated on a surface of the connecting layer;
(12) the conductive substrate comprises at least one of a polymer, an amorphous carbon material and a graphitized carbon material;
(13) a thickness of the connecting layer is 5 nm to 200 nm;
(14) a thickness of the protective layer is 5 nm to 500 nm;
(15) the connecting layer comprises a graphitized carbon material, and the graphitized carbon material is a doping element-containing modified grapheme;
(16) the connecting layer comprises a graphitized carbon material, the graphitized carbon material is a doping element-containing modified grapheme, and a number of layers of the modified graphene is <10;
(17) the connecting layer comprises a graphitized carbon material, the graphitized carbon material is a doping element-containing modified grapheme, and the doping element comprises at least one of oxygen, nitrogen and sulphur;
(18) the connecting layer comprises a graphitized carbon material, the graphitized carbon material is a doping element-containing modified grapheme, and a mass content of the doping element in the graphitized carbon material is 1% to 20%;
(19) the connecting layer comprises a polymer, and the polymer comprises at least one of a double-block copolymer, a tri-block copolymer and a multi-block copolymer;
(20) the connecting layer comprises a polymer, and a mass content of the polymer in the anode material is 1% to 20%; or
(21) the connecting layer comprises a polymer, the polymer comprises at least one of polyacrylic acid, polyacrylonitrile, polyimide, polyurethane, polydopamine, xanthan gum, polypyrrole, polythiophene, polyphenylacetylene, polyaniline, polyacetylene and tannic acid.

7. The anode material according to claim 1, wherein the anode material comprises at least one of following features (1) to (12):
(1) the silicon-based active material is primary particles;
(2) the silicon-based active material comprises at least one of Si, SiOx and silicon alloy, wherein 0<x<2;
(3) a median particle diameter of the silicon-based active material is 0.2 μm to 20 μm;
(4) a mass content of carbon element in the anode material is 5% to 80%;
(5) a mass content of oxygen element in the anode material is smaller than 20%;
(6) a powder tap density of the anode material is 0.2 g/cm³ to 1.2 g/cm³;
(7) a powder compaction density of the anode material is 1.2 g/cm³ to 1.8 g/cm³;
(8) a median particle diameter of the anode material is 0.2 μm to 20 μm;
(9) a specific surface area of the anode material is 1 m²/g to 50 m²/g;
(10) the connecting layer and the protective layer each comprise a ploymer;
(11) the connecting layer and the protective layer each comprise an amorphous carbon material; or
(12) the connecting layer and the protective layer each comprise a graphitized carbon material.

8.-13. (canceled)

14. The anode material according to claim 3, wherein the anode material comprises at least one of following features (1) to (24):
(1) the connecting layer comprises at least one of a polymer, an amorphous carbon material and a graphitized carbon material;
(2) the buffer layer comprises a hollow carbon material;
(3) the buffer layer comprises a hollow carbon material, and the hollow carbon material comprises at least one of hollow carbon sphere, hollow carbon rod and hollow carbon tube;
(4) the buffer layer comprises a hollow carbon material, the hollow carbon material comprises a hollow carbon sphere, and a diameter of the hollow carbon sphere is 20 nm to 2000 nm;
(5) the buffer layer comprises a hollow carbon material, the hollow carbon material comprises a hollow carbon sphere, and a wall thickness of the hollow carbon sphere is 5 nm to 500 nm;
(6) the buffer layer comprises a hollow carbon material, the hollow carbon material comprises a hollow carbon rod, and a diameter of the hollow carbon rod is 10 nm to 1000 nm;
(7) the buffer layer comprises a hollow carbon material, the hollow carbon material comprises a hollow carbon rod, and a length of the hollow carbon rod is 100 nm to 3000 nm;
(8) the buffer layer comprises a hollow carbon material, the hollow carbon material comprises a hollow carbon rod, and a wall thickness of the hollow carbon rod is 5 nm to 500 nm;
(9) the buffer layer comprises a hollow carbon material, the hollow carbon material comprises a hollow carbon tube, and a length of the hollow carbon tube is 30 nm to 20 μm;
(10) the buffer layer comprises a hollow carbon material, the hollow carbon material comprises a hollow carbon tube, and a wall thickness of the hollow carbon tube is 5 nm to 100 nm;
(11) the buffer layer comprises a hollow carbon material, the hollow carbon material comprises a hollow carbon tube, and a diameter of the hollow carbon tube is 20 nm to 400 nm;
(12) a ratio of a thickness of the buffer layer and a median particle diameter D₅₀ of the silica-based active material is 1:(0.5-10);
(13) the protective layer is coated on a surface of the buffer layer;
(14) the buffer layer comprises a hollow carbon material, and at least part of the protective layer is filled in a gap of the hollow carbon material;
(15) the protective layer comprises at least one of a polymer, an amorphous carbon material and a graphitized carbon material;
(16) a thickness of the connecting layer is 5 nm to 200 nm;
(17) a thickness of the protective layer is 5 nm to 500 nm;
(18) the protective layer comprises a graphitized carbon material, and the graphitized carbon material is a doping element-containing modified grapheme;
(19) the protective layer comprises a graphitized carbon material, the graphitized carbon material is a doping element-containing modified grapheme, and a number of layers of the modified graphene is <10;
(20) the protective layer comprises a graphitized carbon material, the graphitized carbon material is a doping element-containing modified grapheme, and the doping element comprises at least one of oxygen, nitrogen and sulphur;
(21) the protective layer comprises a graphitized carbon material, the graphitized carbon material is a doping element-containing modified grapheme, and the mass content of the doping element in the graphitized carbon material is 1% to 20%;
(22) the protective layer comprises a polymer, and the polymer comprises at least one of a double-block copolymer, a tri-block copolymer and a multi-block copolymer;
(23) the protective layer comprises a polymer, the mass content of the polymer in the anode material is 1% to 20%; or
(24) the protective layer comprises a polymer, the polymer comprises at least one of polyacrylic acid, polyacrylonitrile, polyimide, polyurethane, polydopamine, xanthan gum, polypyrrole, polythiophene, polyphenylacetylene, polyaniline, polyacetylene and tannic acid.

15. The anode material according to claim 2, wherein the anode material comprises at least one of following features (1) to (12):
(1) the silicon-based active material is primary particles;
(2) the silicon-based active material comprises at least one of Si, SiOx and silicon alloy, wherein 0<x<2;
(3) a median particle diameter of the silicon-based active material is 0.2 μm to 20 μm;
(4) a mass content of carbon element in the anode material is 5% to 80%;
(5) a mass content of oxygen element in the anode material is smaller than 20%;
(6) a powder tap density of the anode material is 0.2 g/cm³ to 1.2 g/cm³;
(7) a powder compaction density of the anode material is 1.2 g/cm³ to 1.8 g/cm³;
(8) a median particle diameter of the anode material is 0.2 μm to 20 μm;
(9) a specific surface area of the anode material is 1 m²/g to 50 m²/g;
(10) the connecting layer and the protective layer each comprise a ploymer;
(11) the connecting layer and the protective layer each comprise an amorphous carbon material; or
(12) the connecting layer and the protective layer each comprise a graphitized carbon material.

16. The anode material according to claim 3, wherein the anode material comprises at least one of following features (1) to (12):
(1) the silicon-based active material is primary particles;
(2) the silicon-based active material comprises at least one of Si, SiOx and silicon alloy, wherein 0<x<2;
(3) a median particle diameter of the silicon-based active material is 0.2 μm to 20 μm;
(4) a mass content of carbon element in the anode material is 5% to 80%;
(5) a mass content of oxygen element in the anode material is smaller than 20%;
(6) a powder tap density of the anode material is 0.2 g/cm³ to 1.2 g/cm³;
(7) a powder compaction density of the anode material is 1.2 g/cm³ to 1.8 g/cm³;
(8) a median particle diameter of the anode material is 0.2 μm to 20 μm;
(9) a specific surface area of the anode material is 1 m²/g to 50 m²/g;
(10) the connecting layer and the protective layer each comprise a ploymer;
(11) the connecting layer and the protective layer each comprise an amorphous carbon material; or
(12) the connecting layer and the protective layer each comprise a graphitized carbon material.

17. The anode material according to claim 4, wherein the anode material comprises at least one of following features (1) to (12):
(1) the silicon-based active material is primary particles;
(2) the silicon-based active material comprises at least one of Si, SiOx and silicon alloy, wherein 0<x<2;
(3) a median particle diameter of the silicon-based active material is 0.2 μm to 20 μm;
(4) a mass content of carbon element in the anode material is 5% to 80%;
(5) a mass content of oxygen element in the anode material is smaller than 20%;
(6) a powder tap density of the anode material is 0.2 g/cm³ to 1.2 g/cm³;
(7) a powder compaction density of the anode material is 1.2 g/cm³ to 1.8 g/cm³;
(8) a median particle diameter of the anode material is 0.2 μm to 20 μm;
(9) a specific surface area of the anode material is 1 m²/g to 50 m²/g;
(10) the connecting layer and the protective layer each comprise a ploymer;
(11) the connecting layer and the protective layer each comprise an amorphous carbon material; or
(12) the connecting layer and the protective layer each comprise a graphitized carbon material.

18. The anode material according to claim 5, wherein the anode material comprises at least one of following features (1) to (12):
(1) the silicon-based active material is primary particles;
(2) the silicon-based active material comprises at least one of Si, SiOx and silicon alloy, wherein 0<x<2;
(3) a median particle diameter of the silicon-based active material is 0.2 μm to 20 μm;
(4) a mass content of carbon element in the anode material is 5% to 80%;
(5) a mass content of oxygen element in the anode material is smaller than 20%;
(6) a powder tap density of the anode material is 0.2 g/cm³ to 1.2 g/cm³;
(7) a powder compaction density of the anode material is 1.2 g/cm³ to 1.8 g/cm³;
(8) a median particle diameter of the anode material is 0.2 μm to 20 μm;
(9) a specific surface area of the anode material is 1 m²/g to 50 m²/g;
(10) the connecting layer and the protective layer each comprise a ploymer;
(11) the connecting layer and the protective layer each comprise an amorphous carbon material; or
(12) the connecting layer and the protective layer each comprise a graphitized carbon material.

19. The anode material according to claim 6, wherein the anode material comprises at least one of following features (1) to (12):
(1) the silicon-based active material is primary particles;
(2) the silicon-based active material comprises at least one of Si, SiOx and silicon alloy, wherein 0<x<2;
(3) a median particle diameter of the silicon-based active material is 0.2 μm to 20 μm;
(4) a mass content of carbon element in the anode material is 5% to 80%;
(5) a mass content of oxygen element in the anode material is smaller than 20%;
(6) a powder tap density of the anode material is 0.2 g/cm³ to 1.2 g/cm³;
(7) a powder compaction density of the anode material is 1.2 g/cm³ to 1.8 g/cm³;
(8) a median particle diameter of the anode material is 0.2 μm to 20 μm;
(9) a specific surface area of the anode material is 1 m²/g to 50 m²/g;
(10) the connecting layer and the protective layer each comprise a ploymer;
(11) the connecting layer and the protective layer each comprise an amorphous carbon material; or
(12) the connecting layer and the protective layer each comprise a graphitized carbon material.
